(19) United States
(12) Patent Application Publication
(10) Pub. No.: US 2016/0161343 A1
(43) Pub. Date: Jun. 9, 2016

(54) Methods of On-Actuator Temperature Measurement

(71) Applicant: ADVANCED LIQUID LOGIC, INC., San Diego, CA (US)

(72) Inventors: Gregory SMITH, Cary, NC (US); Randall L. LUCK, Cary, NC (US)

(73) Assignee: Advanced Liquid Logic, Inc., San Diego, CA (US)

(21) Appl. No.: 14/905,679

(22) PCT Filed: Jul. 21, 2014
(86) PCT No.: PCT/US2014/047449

§ 371 Date: Jan. 15, 2016

Related U.S. Application Data
(60) Provisional application No. 61/856,429, filed on Jul. 19, 2013.

(51) Int. Cl. G01K 7/16; G01K 13/00

(52) U.S. Cl. CPC G01K 7/16; G01K 13/00

(57) ABSTRACT

The present invention provides methods for on-actuator temperature measurement and temperature control, including where one or more of the temperature sensors are combined with one or more heaters that are formed of wiring traces and/or providing heaters designed for one-to-one correspondence to the temperature sensors to form temperature sensor-heater pairs. The present invention also provides methods for on-actuator temperature measurement and temperature control in which the temperature sensors comprise a connection comprising a plurality of terminals by which an amount of current can be applied and then a voltage measured, wherein the voltage that is measured across the temperature sensors can be accurately correlated to a temperature.

### 1 RELATED APPLICATIONS

In addition to the patent applications cited herein, each of which is incorporated herein by reference, this patent application is related to and claims priority to U.S. Provisional Patent Application No. 61/856,429, filed on Jul. 19, 2013, entitled “Methods of On-Actuator Temperature Measurement;” the entire disclosure of which is incorporated herein by reference.

### 2 FIELD OF THE INVENTION

The invention relates to methods of monitoring and controlling temperature in a droplet actuator, comprising on-actuator temperature measurement and temperature control.

### 3 BACKGROUND

A droplet actuator typically includes one or more substrates configured to form a surface or gap for conducting droplet operations. The one or more substrates establish a droplet operations surface or gap for conducting droplet operations and may also include electrodes arranged to conduct the droplet operations. The droplet operations substrate or the gap between the substrates may be coated or filled with a filler fluid that is immiscible with the liquid that forms the droplets. Droplet actuators may include heating zones in which droplet operations are conducted. Current methods of monitoring and controlling the heating zones can be inaccurate. Therefore, there is a need for new approaches to controlling temperature in a droplet actuator.

### 4 BRIEF DESCRIPTION OF THE INVENTION

The invention relates to a method of on-actuator temperature measurement and control, comprising providing one or more droplets on a droplet actuator and measuring the temperature of the one or more droplets with one or more temperature sensors on the droplet actuator, wherein each of the one or more temperature sensors comprise a temperature sensor wiring trace and a connection, wherein the connection comprises a plurality of terminals configured to enable application of an amount of current from a current source and measurement of a voltage, wherein the voltage correlates to a temperature. In some embodiments, the temperature sensor wiring trace is disposed on a printed circuit board (PCB). In other embodiments, at least one of the connections is a Kelvin electrical connection, particularly wherein the Kelvin electrical connection comprises a resistor R1, more particularly wherein the resistor R1 is configured to measure the resistance of the one or more temperature sensors. In a further embodiment, the Kelvin electrical connection comprises a 4-terminal Kelvin connection comprising a terminal T1, a terminal T2, a terminal T3, and a terminal T4. In yet another embodiment, the terminal T1 and the terminal T2 comprise current terminals, particularly wherein the resistor R1 is arranged between the terminal T1 and the terminal T2, and more particularly wherein the terminal T1 and the terminal T2 are configured to be driven by a constant current source. In another embodiment, the Kelvin electrical connection further comprises a resistor R2 and a resistor R3, particularly wherein the Kelvin electrical connection further comprises a loop comprising the resistor R1, the resistor R2, the resistor R3, and the current source. In a still further embodiment, the terminal T3 and the terminal T4 comprise sense terminals, particularly wherein the terminal T3 and the terminal T4 are configured to measure the voltage across resistor R1. In another embodiment, the Kelvin electrical connection further comprises a resistor R4 and a resistor R5, particularly wherein the Kelvin electrical connection further comprises a loop comprising the resistor R1, the resistor R4, the resistor R5, and the voltage.

In another embodiment of the method of on-actuator temperature measurement and control, one of the one or more temperature sensors comprises a first temperature sensor comprising the 4-terminal Kelvin connection, further wherein one or more additional temperature sensors comprise 2-terminal connections, particularly wherein the connections are configured to enable current to run in series through the first temperature sensor and the one or more additional temperature sensors. In a further embodiment, the one or more additional temperature sensors share the same current source.

In another embodiment of the method of on-actuator temperature measurement and control, the droplet actuator further comprises one or more heaters, wherein each of the one or more heaters comprise a heater wiring trace. In a further embodiment, each of the one or more temperature sensors corresponds to a heater, thereby forming one or more temperature sensor-heater pairs, particularly wherein the temperature sensor wiring trace and the heater wiring trace of each of the one or more temperature sensor-heater pairs comprise the same wiring trace.

In another embodiment of the method of on-actuator temperature measurement and control, the droplet actuator is configured to prevent the temperature of the temperature sensor wiring trace from increasing by more than about 0.1° C. In a further embodiment, the droplet actuator is configured to enable pulsed measurements. In yet another embodiment, the droplet actuator is configured to enable oversampling using continuous measurement. In still another embodiment, the droplet actuator is configured to enable exclusion of a thermal electromotive force (EMF) from the measurement of the voltage, particularly wherein the droplet actuator is configured to enable exclusion of the thermal EMF from the measurement of the voltage through via an Offset Compensation method, a Current Reversal method, a Delta method, or a Lock-in method.

In another embodiment of the method of on-actuator temperature measurement and control, the temperature sensor wiring trace is configured to form a defined shape or geometric pattern, particularly a substantially circular pattern or a substantially square pattern. In another embodiment, the temperature sensor wiring trace comprises a 7-loop temperature sensor, a 5-loop temperature sensor, a 3-loop temperature sensor, or a 1-loop temperature sensor. In another embodiment, the temperature sensor wiring trace also comprises an on-actuator temperature sensor. In a further embodiment, at least one of the connections is a Kelvin electrical connection, particularly wherein the Kelvin electrical connection comprises a resistor R1, even more particularly wherein the resistor R1 is configured to measure the resistance of the one or more temperature sensors. In a further embodiment, the Kelvin electrical connection comprises a 4-terminal Kelvin connection comprising a terminal T1, a terminal T2, a terminal T3, and a terminal T4. In yet another embodiment, the temperature sensor wiring trace comprises a continuous wiring trace, particularly wherein the continuous wiring trace is configured in a serpentine shape comprising one or more concentric circles about a center point. In still another embodiment, terminals T1 and T3 are located at one end of the temperature sensor wiring trace and terminals T2 and T4 are located at the other end of the temperature sensor wiring trace. In yet another embodiment, the temperature sensor wiring trace corresponds to resistor R1. In a further embodiment, the droplet actuator further comprises one or more heaters, wherein each of the one or more heaters comprises a heater wiring trace. In another embodiment, each of the one or more temperature sensors corresponds to a heater, thereby forming one or more temperature sensor-heater pairs, particularly wherein the temperature sensor wiring trace and the heater wiring trace of each of the one or more temperature sensor-heater pairs comprise the same wiring trace. In a further embodiment, each of the one or more temperature sensor-heater pairs are configured to enable one or more printed circuit board (PCB) substrates to be located in the spaces within and/or around the temperature sensor trace and the heater sensor trace. In a still further embodiment, the overall area of the heater is larger than the overall area of the temperature sensor, particularly wherein the overall area of the heater is about 5.5 mm by about 5.5 mm, and wherein the overall area of the temperature sensor is about 4.375 mm by about 4.375 mm.

In another embodiment of the method of on-actuator temperature measurement and control, the heater wiring trace comprises an on-actuator heater. In one embodiment, the temperature sensor wiring trace comprises a thickness of about, 17 μm, a width of about 125 μm, a length of about 49.65 mm, a resistance R of about 0.402 ohms at about 20° C., a sensitivity of about 54 μV/° C., and an alpha (α) of about 0.00384, wherein α is the temperature coefficient per ° C. In another embodiment, the temperature sensor wiring trace comprises a resistance R of about 0.485 ohms at about −10° C. and about 0.759 ohms at about 120° C. In another embodiment, the temperature sensor wiring trace comprises a resistance R of about 0.548 ohms at about 20° C. and an alpha (α) of about 0.0038537. In another embodiment, the temperature sensor wiring trace comprises a thickness of about, 17 μm, a width of about 125 μm, a length of about 76.88 mm, a resistance R of about 0.623 ohms at about 20° C. In another embodiment, the temperature sensor wiring trace comprises a resistance R of about 0.551 ohms at about −10° C. and about 0.862 ohms at about 120° C. In another embodiment, the temperature sensor wiring trace comprises copper, particularly wherein the temperature sensor wiring trace comprises ½-ounce copper. In another embodiment, the heater wiring trace comprises a material more resistive than copper, particularly wherein the material more resistive than copper is selected from the group consisting of a nickel phosphorus (NiP) alloy, a nickel chromium (NiCr) alloy, nickel chromium aluminum silicon (NCAS), chromium silicon monoxide (CrSiO), and a carbon based ink.

In another embodiment of the method of on-actuator temperature measurement and control, the droplet actuator comprises a plurality of heaters, wherein a side of each of the plurality of heaters is electrically connected in common, and wherein the other sides of each of the plurality of heaters comprise separate electrical connections, particularly wherein the side of each of the plurality of heaters that is electrically connected in common each use the same connection, more particularly wherein the connection comprises a connector that is spatially separated from the heater.

In another embodiment of the method of on-actuator temperature measurement and control, one of the one or more temperature sensors comprises a first temperature sensor comprising the 4-terminal Kelvin connection, and further wherein one or more additional temperature sensors comprise 2-terminal connections. In another embodiment, the connections are configured to enable current to run in series through the first temperature sensor and the one or more additional temperature sensors, particularly wherein the one or more additional temperature sensors share the same current source. In another embodiment, the temperature sensor and the heater are substantially aligned, particularly wherein the temperature sensor and the heater are located on different layers of a bottom substrate, wherein the droplet actuator comprises the bottom substrate and a top substrate separated by a droplet operations gap. In another embodiment, the droplet actuator comprises a printed circuit board (PCB) stack comprising a temperature sensor layer, a heater layer, and an electrode layer, particularly wherein the bottom substrate comprises a multi-layer PCB comprising a configuration of a signal layer, a power layer, and a ground layer, more particularly wherein droplet operations electrodes are disposed on a layer L1, the temperature sensor is disposed on a layer L2, and the heater is disposed on a layer L4. In another embodiment, the temperature sensor on layer L2 and the heater on layer L4 are substantially aligned with a droplet operations electrode disposed on the layer L1, particularly wherein the temperature sensor on layer L2 is disposed on the PCB layer closest to the droplet operations electrode.

In another embodiment of the method of on-actuator temperature measurement and control, a plurality of temperature sensor-heater pairs are configured in a temperature sensor-heater pair array. In another embodiment, the temperature sensor wiring trace and the heater wiring trace are configured to form a defined shape or geometric pattern, particularly wherein the defined shape or geometric pattern is selected from the group consisting of linear, circular, ovular or elliptical, square, rectangular, triangular, hexagonal, spiral, and fractal. In another embodiment, each of the one or more temperature sensor-heater pairs are formed from the same wiring trace, thereby forming one or more combination sensor/heater traces, particularly wherein the droplet actuator is configured to control the one or more combination sensor/heater traces using an electronic multiplexing technique, more particularly wherein the electronic multiplexing technique is pulse-width modulation. In another embodiment, the droplet actuator is configured to measure the temperature sensors by sequentially scanning each temperature sensor and measuring the resistance of the temperature sensor, particularly wherein the droplet actuator further comprises a field-programmable gate array (FPGA) under the control of a microcontroller, and more particularly wherein the droplet actuator further comprises a complex programmable logic device (CPLD) under the control of a microcontroller. In another embodiment, the droplet actuator is configured to independently control each of the one or more heaters.

### 5 BRIEF DESCRIPTION OF THE DRAWINGS

FIG. 1 illustrates a schematic diagram of a Kelvin electrical connection;

FIGS. 2, 3, 4, and 5 illustrate plan views of four examples, respectively, of temperature sensors formed of wiring traces laid out in circular patterns;

FIG. 6A illustrates a plan view of another example of a temperature sensor, wherein the temperature sensor is formed of wiring traces laid out in a square pattern;

FIG. 6B illustrates a plan view of an example of a heater trace that is designed to substantially correspond to the temperature sensor shown in FIG. 6A;

FIG. 7 illustrates a plan view of an example of an array of the heater trace shown in FIG. 6B;

FIG. 8 illustrates a cross-sectional view of an example of an electrode-temperature sensor-heater stack in a droplet actuator;

FIG. 9 illustrates a plan view of an example of a set of non-copper heaters;

FIGS. 10A, 10B, and 10C illustrate plan views of examples of configuring the connections of temperature sensors;

FIG. 11 shows an example of a set of heaters in relation to a plot of heat profiles in the droplet actuator;

FIG. 12 illustrates a functional block diagram of an example of a microfluidics system;

FIG. 13 illustrates a block diagram showing more details of the calibration portion of the microfluidics system and droplet actuator of FIG. 12; and

FIG. 14 shows an example of a plot of the resistance vs. temperature for a copper temperature sensor.

### 6 DEFINITIONS

As used herein, the following terms have the meanings indicated.

“Activate,” with reference to one or more electrodes, means affecting a change in the electrical state of the one or more electrodes which, in the presence of a droplet, results in a droplet operation. Activation of an electrode can be accomplished using alternating or direct current. Any suitable voltage may be used. For example, an electrode may be activated using a voltage which is greater than about 150 V, or greater than about 200 V, or greater than about 250 V, or from about 275 V to about 1000 V, or about 300 V. Where alternating current is used, any suitable frequency may be employed. For example, an electrode may be activated using alternating current having a frequency from about 1 Hz to about 10 MHz, or from about 10 Hz to about 60 Hz, or from about 20 Hz to about 40 Hz, or about 30 Hz.

“Bead,” with respect to beads on a droplet actuator, means any bead or particle that is capable of interacting with a droplet on or in proximity with a droplet actuator. Beads may be any of a wide variety of shapes, such as spherical, generally spherical, egg shaped, disc shaped, cubical, amorphous and other three dimensional shapes. The bead may, for example, be capable of being subjected to a droplet operation in a droplet on a droplet actuator or otherwise configured with respect to a droplet actuator in a manner which permits a droplet on the droplet actuator to be brought into contact with the bead on the droplet actuator and/or off the droplet actuator. Beads may be provided in a droplet, in a droplet operations gap, or on a droplet operations surface. Beads may be provided in a reservoir that is external to a droplet operations gap or situated apart from a droplet operations surface, and the reservoir may be associated with a flow path that permits a droplet including the beads to be brought into a droplet operations gap or into contact with a droplet operations surface. Beads may be manufactured using a wide variety of materials, including for example, resins, and polymers. The beads may be any suitable size, including for example, microbeads, microparticles, nanobeads and nanoparticles. In some cases, beads are magnetically responsive; in other cases beads are not significantly magnetically responsive. For magnetically responsive beads, the magnetically responsive material may constitute substantially all of a bead, a portion of a bead, or only one component of a bead. The remainder of the bead may include, among other things, polymeric material, coatings, and moieties which permit attachment of an assay reagent. Examples of suitable beads include flow cytometry microbeads, polystyrene microparticles and nanoparticles, functionalized polystyrene microparticles and nanoparticles, coated polystyrene microparticles and nanoparticles, silica microbeads, fluorescent microspheres and nanospheres, functionalized fluorescent microspheres and nanospheres, coated fluorescent microspheres and nanospheres, color dyed microparticles and nanoparticles, magnetic microparticles and nanoparticles, superparamagnetic microparticles and nanoparticles (e.g., DYNABEADS® particles, available from Invitrogen Group, Carlsbad, Calif.), fluorescent microparticles and nanoparticles, coated magnetic microparticles and nanoparticles, ferromagnetic microparticles and nanoparticles, coated ferromagnetic microparticles and nanoparticles, and those described in U.S. Patent Publication Nos. 20050260686, entitled “Multiplex flow assays preferably with magnetic particles as solid phase,” published on Nov. 24, 2005; 20030132538, entitled “Encapsulation of discrete quanta of fluorescent particles,” published on Jul. 17, 2003; 20050118574, entitled “Multiplexed Analysis of Clinical Specimens Apparatus and Method,” published on Jun. 2, 2005; 20050277197. Entitled “Microparticles with Multiple Fluorescent Signals and Methods of Using Same,” published on Dec. 15, 2005; 20060159962, entitled “Magnetic Microspheres for use in Fluorescence-based Applications,” published on Jul. 20, 2006; the entire disclosures of which are incorporated herein by reference for their teaching concerning beads and magnetically responsive materials and beads. Beads may be pre-coupled with a biomolecule or other substance that is able to bind to and form a complex with a biomolecule. Beads may be pre-coupled with an antibody, protein or antigen, DNA/RNA probe or any other molecule with an affinity for a desired target. Examples of droplet actuator techniques for immobilizing magnetically responsive beads and/or non-magnetically responsive beads and/or conducting droplet operations protocols using beads are described in U.S. patent application Ser. No. 11/639,566, entitled “Droplet-Based Particle Sorting,” filed on Dec. 15, 2006; U.S. Patent Application No. 61/039,183, entitled “Multiplexing Bead Detection in a Single Droplet,” filed on Mar. 25, 2008; U.S. Patent Application No. 61/047,789, entitled “Droplet Actuator Devices and Droplet Operations Using Beads,” filed on Apr. 25, 2008; U.S. Patent Application No. 61/086,183, entitled “Droplet Actuator Devices and Methods for Manipulating Beads,” filed on Aug. 5, 2008; International Patent Application No. PCT/US2008/053545, entitled “Droplet Actuator Devices and Methods Employing Magnetic Beads,” filed on Feb. 11, 2008; International Patent Application No. PCT/US2008/058018, entitled “Bead-based Multiplexed Analytical Methods and Instrumentation,” filed on Mar. 24, 2008; International Patent Application No. PCT/US2008/058047, “Bead Sorting on a Droplet Actuator,” filed on Mar. 23, 2008; and International Patent Application No. PCT/US2006/047486, entitled “Droplet-based Biochemistry,” filed on Dec. 11, 2006; the entire disclosures of which are incorporated herein by reference. Bead characteristics may be employed in the multiplexing aspects of the invention. Examples of beads having characteristics suitable for multiplexing, as well as methods of detecting and analyzing signals emitted from such beads, may be found in U.S. Patent Publication No. 20080305481, entitled “Systems and Methods for Multiplex Analysis of PCR in Real Time,” published on Dec. 11, 2008; U.S. Patent Publication No. 20080151240, “Methods and Systems for Dynamic Range Expansion,” published on Jun. 26, 2008; U.S. Patent Publication No. 20070207513, entitled “Methods, Products, and Kits for Identifying an Analyte in a Sample,” published on Sep. 6, 2007; U.S. Patent Publication No. 20070064990, entitled “Methods and Systems for Image Data Processing,” published on Mar. 22, 2007; U.S. Patent Publication No. 20060159962, entitled “Magnetic Microspheres for use in Fluorescence-based Applications,” published on Jul. 20, 2006; U.S. Patent Publication No. 20050277197, entitled “Microparticles with Multiple Fluorescent Signals and Methods of Using Same,” published on Dec. 15, 2005; and U.S. Patent Publication No. 20050118574, entitled “Multiplexed Analysis of Clinical Specimens Apparatus and Method,” published on Jun. 2, 2005.

“Droplet” means a volume of liquid on a droplet actuator. Typically, a droplet is at least partially bounded by a filler fluid. For example, a droplet may be completely surrounded by a filler fluid or may be bounded by filler fluid and one or more surfaces of the droplet actuator. As another example, a droplet may be bounded by filler fluid, one or more surfaces of the droplet actuator, and/or the atmosphere. As yet another example, a droplet may be bounded by filler fluid and the atmosphere. Droplets may, for example, be aqueous or non-aqueous or may be mixtures or emulsions including aqueous and non-aqueous components. Droplets may take a wide variety of shapes; nonlimiting examples include generally disc shaped, slug shaped, truncated sphere, ellipsoid, spherical, partially compressed sphere, hemispherical, ovoid, cylindrical, combinations of such shapes, and various shapes formed during droplet operations, such as merging or splitting or formed as a result of contact of such shapes with one or more surfaces of a droplet actuator. For examples of droplet fluids that may be subjected to droplet operations using the approach of the invention, see International Patent Application No. PCT/US 06/47486, entitled, “Droplet-Based Biochemistry,” filed on Dec. 11, 2006. In various embodiments, a droplet may include a biological sample, such as whole blood, lymphatic fluid, serum, plasma, sweat, tear, saliva, sputum, cerebrospinal fluid, amniotic fluid, seminal fluid, vaginal excretion, serous fluid, synovial fluid, pericardial fluid, peritoneal fluid, pleural fluid, transudates, exudates, cystic fluid, bile, urine, gastric fluid, intestinal fluid, fecal samples, liquids containing single or multiple cells, liquids containing organelles, fluidized tissues, fluidized organisms, liquids containing multi-celled organisms, biological swabs and biological washes. Moreover, a droplet may include a reagent, such as water, deionized water, saline solutions, acidic solutions, basic solutions, detergent solutions and/or buffers. Other examples of droplet contents include reagents, such as a reagent for a biochemical protocol, such as a nucleic acid amplification protocol, an affinity-based assay protocol, an enzymatic assay protocol, a sequencing protocol, and/or a protocol for analyses of biological fluids. A droplet may include one or more beads.

“Droplet Actuator” means a device for manipulating droplets. For examples of droplet actuators, see Pamula et al., U.S. Pat. No. 6,911,132, entitled “Apparatus for Manipulating Droplets by Electrowetting-Based Techniques,” issued on Jun. 28, 2005; Pamula et al., U.S. patent application Ser. No. 11/343,284, entitled “Apparatuses and Methods for Manipulating Droplets on a Printed Circuit Board,” filed on filed on Jan. 30, 2006; Pollack et al., International Patent Application No. PCT/US2006/047486, entitled “Droplet-Based Biochemistry,” filed on Dec. 11, 2006; Shenderov, U.S. Pat. No. 6,773,566, entitled “Electrostatic Actuators for Microfluidics and Methods for Using Same,” issued on Aug. 10, 2004 and U.S. Pat. No. 6,565,727, entitled “Actuators for Microfluidics Without Moving Parts,” issued on Jan. 24, 2000; Kim and/or Shah et al., U.S. patent application Ser. No. 10/343,261, entitled “Electrowetting-driven Micropumping,” filed on Jan. 27, 2003, Ser. No. 11/275,668, entitled “Method and Apparatus for Promoting the Complete Transfer of Liquid Drops from a Nozzle,” filed on Jan. 23, 2006, Ser. No. 11/460,188, entitled “Small Object Moving on Printed Circuit Board,” filed on Jan. 23, 2006, Ser. No. 12/465,935, entitled “Method for Using Magnetic Particles in Droplet Microfluidics,” filed on May 14, 2009, and Ser. No. 12/513,157, entitled “Method and Apparatus for Real-time Feedback Control of Electrical Manipulation of Droplets on Chip,” filed on Apr. 30, 2009; Velev, U.S. Pat. No. 7,547,380, entitled “Droplet Transportation Devices and Methods Having a Fluid Surface,” issued on Jun. 16, 2009; Sterling et al., U.S. Pat. No. 7,163,612, entitled “Method, Apparatus and Article for Microfluidic Control via Electrowetting, for Chemical, Biochemical and Biological Assays and the Like,” issued on Jan. 16, 2007; Becker and Gascoyne et al., U.S. Pat. No. 7,641,779, entitled “Method and Apparatus for Programmable fluidic Processing,” issued on Jan. 5, 2010, and U.S. Pat. No. 6,977,033, entitled “Method and Apparatus for Programmable fluidic Processing,” issued on Dec. 20, 2005; Decre et al., U.S. Pat. No. 7,328,979, entitled “System for Manipulation of a Body of Fluid,” issued on Feb. 12, 2008; Yamakawa et al., U.S. Patent Pub. No. 20060039823, entitled “Chemical Analysis Apparatus,” published on Feb. 23, 2006; Wu, International Patent Pub. No. WO/2009/003184, entitled “Digital Microfluidics Based Apparatus for Heat-exchanging Chemical Processes,” published on Dec. 31, 2008; Fouillet et al., U.S. Patent Pub. No. 20090192044, entitled “Electrode Addressing Method,” published on Jul. 30, 2009; Fouillet et al., U.S. Pat. No. 7,052,244, entitled “Device for Displacement of Small Liquid Volumes Along a Micro-catenary Line by Electrostatic Forces,” issued on May 30, 2006; Marchand et al., U.S. Patent Pub. No. 20080124252, entitled “Droplet Microreactor,” published on May 29, 2008; Adachi et al., U.S. Patent Pub. No. 20090321262, entitled “Liquid Transfer Device,” published on Dec. 31, 2009; Roux et al., U.S. Patent Pub. No. 20050179746, entitled “Device for Controlling the Displacement of a Drop Between two or Several Solid Substrates,” published on Aug. 18, 2005; Dhindsa et al., “Virtual Electrowetting Channels: Electronic Liquid Transport with Continuous Channel Functionality,” Lab Chip, 10:832-836 (2010); the entire disclosures of which are incorporated herein by reference, along with their priority documents. Certain droplet actuators will include one or more substrates arranged with a droplet operations gap therebetween and electrodes associated with (e.g., layered on, attached to, and/or embedded in) the one or more substrates and arranged to conduct one or more droplet operations. For example, certain droplet actuators will include a base (or bottom) substrate, droplet operations electrodes associated with the substrate, one or more dielectric layers atop the substrate and/or electrodes, and optionally one or more hydrophobic layers atop the substrate, dielectric layers and/or the electrodes forming a droplet operations surface. A top substrate may also be provided, which is separated from the droplet operations surface by a gap, commonly referred to as a droplet operations gap. Various electrode arrangements on the top and/or bottom substrates are discussed in the above-referenced patents and applications and certain novel electrode arrangements are discussed in the description of the invention. During droplet operations it is preferred that droplets remain in continuous contact or frequent contact with a ground or reference electrode. A ground or reference electrode may be associated with the top substrate facing the gap, the bottom substrate facing the gap, in the gap. Where electrodes are provided on both substrates, electrical contacts for coupling the electrodes to a droplet actuator instrument for controlling or monitoring the electrodes may be associated with one or both plates. In some cases, electrodes on one substrate are electrically coupled to the other substrate so that only one substrate is in contact with the droplet actuator. In one embodiment, a conductive material (e.g., an epoxy, such as MASTER BOND™ Polymer System EP79, available from Master Bond, Inc., Hackensack, N.J.) provides the electrical connection between electrodes on one substrate and electrical paths on the other substrates, e.g., a ground electrode on a top substrate may be coupled to an electrical path on a bottom substrate by such a conductive material. Where multiple substrates are used, a spacer may be provided between the substrates to determine the height of the gap therebetween and define dispensing reservoirs. The spacer height may, for example, be from about 5 μm to about 600 μm, or about 100 μm to about 400 μm, or about 200 μm to about 350 μm, or about 250 μm to about 300 μm, or about 275 μm. The spacer may, for example, be formed of a layer of projections form the top or bottom substrates, and/or a material inserted between the top and bottom substrates. One or more openings may be provided in the one or more substrates for forming a fluid path through which liquid may be delivered into the droplet operations gap. The one or more openings may in some cases be aligned for interaction with one or more electrodes, e.g., aligned such that liquid flowed through the opening will come into sufficient proximity with one or more droplet operations electrodes to permit a droplet operation to be effected by the droplet operations electrodes using the liquid. The base (or bottom) and top substrates may in some cases be formed as one integral component. One or more reference electrodes may be provided on the base (or bottom) and/or top substrates and/or in the gap. Examples of reference electrode arrangements are provided in the above referenced patents and patent applications. In various embodiments, the manipulation of droplets by a droplet actuator may be electrode mediated, e.g., electrowetting mediated or dielectrophoresis mediated or Coulombic force mediated. Examples of other techniques for controlling droplet operations that may be used in the droplet actuators of the invention include using devices that induce hydrodynamic fluidic pressure, such as those that operate on the basis of mechanical principles (e.g. external syringe pumps, pneumatic membrane pumps, vibrating membrane pumps, vacuum devices, centrifugal forces, piezoelectric/ultrasonic pumps and acoustic forces); electrical or magnetic principles (e.g. electroosmotic flow, electrokinetic pumps, ferrofluidic plugs, electrohydrodynamic pumps, attraction or repulsion using magnetic forces and magnetohydrodynamic pumps); thermodynamic principles (e.g. gas bubble generation/phase-change-induced volume expansion); other kinds of surface-wetting principles (e.g. electrowetting, and optoelectrowetting, as well as chemically, thermally, structurally and radioactively induced surface-tension gradients); gravity; surface tension (e.g., capillary action); electrostatic forces (e.g., electroosmotic flow); centrifugal flow (substrate disposed on a compact disc and rotated); magnetic forces (e.g., oscillating ions causes flow); magnetohydrodynamic forces; and vacuum or pressure differential. In certain embodiments, combinations of two or more of the foregoing techniques may be employed to conduct a droplet operation in a droplet actuator of the invention. Similarly, one or more of the foregoing may be used to deliver liquid into a droplet operations gap, e.g., from a reservoir in another device or from an external reservoir of the droplet actuator (e.g., a reservoir associated with a droplet actuator substrate and a flow path from the reservoir into the droplet operations gap). Droplet operations surfaces of certain droplet actuators of the invention may be made from hydrophobic materials or may be coated or treated to make them hydrophobic. For example, in some cases some portion or all of the droplet operations surfaces may be derivatized with low surface-energy materials or chemistries, e.g., by deposition or using in situ synthesis using compounds such as poly- or per-fluorinated compounds in solution or polymerizable monomers. Examples include TEFLON® AF (available from DuPont, Wilmington, Del.), members of the cytop family of materials, coatings in the FLUOROPEL® family of hydrophobic and superhydrophobic coatings (available from Cytonix Corporation, Beltsville, Md.), silane coatings, fluorosilane coatings, hydrophobic phosphonate derivatives (e.g., those sold by Aculon, Inc), and NOVEC™ electronic coatings (available from 3M Company, St. Paul, Minn.), other fluorinated monomers for plasma-enhanced chemical vapor deposition (PECVD), and organosiloxane (e.g., SiOC) for PECVD. In some cases, the droplet operations surface may include a hydrophobic coating having a thickness ranging from about 10 nm to about 1,000 nm. Moreover, in some embodiments, the top substrate of the droplet actuator includes an electrically conducting organic polymer, which is then coated with a hydrophobic coating or otherwise treated to make the droplet operations surface hydrophobic. For example, the electrically conducting organic polymer that is deposited onto a plastic substrate may be poly(3,4-ethylenedioxythiophene) poly(styrenesulfonate) (PEDOT:PSS). Other examples of electrically conducting organic polymers and alternative conductive layers are described in Pollack et al., International Patent Application No. PCT/US2010/040705, entitled “Droplet Actuator Devices and Methods,” the entire disclosure of which is incorporated herein by reference. One or both substrates may be fabricated using a printed circuit board (PCB), glass, indium tin oxide (ITO)-coated glass, and/or semiconductor materials as the substrate. When the substrate is ITO-coated glass, the ITO coating is preferably a thickness in the range of about 20 to about 200 nm, preferably about 50 to about 150 nm, or about 75 to about 125 nm, or about 100 nm. In some cases, the top and/or bottom substrate includes a PCB substrate that is coated with a dielectric, such as a polyimide dielectric, which may in some cases also be coated or otherwise treated to make the droplet operations surface hydrophobic. When the substrate includes a PCB, the following materials are examples of suitable materials: MITSUI™ BN-300 (available from MITSUI Chemicals America, Inc., San Jose Calif.); ARLON™ 11N (available from Arlon, Inc, Santa Ana, Calif.).; NELCO® N4000-6 and N5000-30/32 (available from Park Electrochemical Corp., Melville, N.Y.); ISOLA™ FR406 (available from Isola Group, Chandler, Ariz.), especially IS620; fluoropolymer family (suitable for fluorescence detection since it has low background fluorescence); polyimide family; polyester; polyethylene naphthalate; polycarbonate; polyetheretherketone; liquid crystal polymer; cyclo-olefin copolymer (COC); cyclo-olefin polymer (COP); aramid; THERMOUNT® nonwoven aramid reinforcement (available from DuPont, Wilmington, Del.); NOMEX® brand fiber (available from DuPont, Wilmington, Del.); and paper. Various materials are also suitable for use as the dielectric component of the substrate. Examples include: vapor deposited dielectric, such as PARYLENE™ C (especially on glass), PARYLENE™ N, and PARYLENE™ HT (for high temperature, ˜300° C.) (available from Parylene Coating Services, Inc., Katy, Tex.); TEFLON® AF coatings; cytop; soldermasks, such as liquid photoimageable soldermasks (e.g., on PCB) like TAIYO™ PSR4000 series, TAIYO™ PSR and AUS series (available from Taiyo America, Inc. Carson City, Nev.) (good thermal characteristics for applications involving thermal control), and PROBIMER™ 8165 (good thermal characteristics for applications involving thermal control (available from Huntsman Advanced Materials Americas Inc., Los Angeles, Calif.); dry film soldermask, such as those in the VACREL® dry film soldermask line (available from DuPont, Wilmington, Del.); film dielectrics, such as polyimide film (e.g., KAPTON® polyimide film, available from DuPont, Wilmington, Del.), polyethylene, and fluoropolymers (e.g., FEP), polytetrafluoroethylene; polyester; polyethylene naphthalate; cyclo-olefin copolymer (COC); cyclo-olefin polymer (COP); any other PCB substrate material listed above; black matrix resin; polypropylene; and black flexible circuit materials, such as DuPont™ Pyralux® HXC and DuPont™ Kapton® MBC (available from DuPont, Wilmington, Del.). Droplet transport voltage and frequency may be selected for performance with reagents used in specific assay protocols. Design parameters may be varied, e.g., number and placement of on-actuator reservoirs, number of independent electrode connections, size (volume) of different reservoirs, placement of magnets/bead washing zones, electrode size, inter-electrode pitch, and gap height (between top and bottom substrates) may be varied for use with specific reagents, protocols, droplet volumes, etc. In some cases, a substrate of the invention may derivatized with low surface-energy materials or chemistries, e.g., using deposition or in situ synthesis using poly- or per-fluorinated compounds in solution or polymerizable monomers. Examples include TEFLON® AF coatings and FLUOROPEL® coatings for dip or spray coating, other fluorinated monomers for plasma-enhanced chemical vapor deposition (PECVD), and organosiloxane (e.g., SiOC) for PECVD. Additionally, in some cases, some portion or all of the droplet operations surface may be coated with a substance for reducing background noise, such as background fluorescence from a PCB substrate. For example, the noise-reducing coating may include a black matrix resin, such as the black matrix resins available from Toray industries, Inc., Japan. Electrodes of a droplet actuator are typically controlled by a controller or a processor, which is itself provided as part of a system, which may include processing functions as well as data and software storage and input and output capabilities. Reagents may be provided on the droplet actuator in the droplet operations gap or in a reservoir fluidly coupled to the droplet operations gap. The reagents may be in liquid form, e.g., droplets, or they may be provided in a reconstitutable form in the droplet operations gap or in a reservoir fluidly coupled to the droplet operations gap. Reconstitutable reagents may typically be combined with liquids for reconstitution. An example of reconstitutable reagents suitable for use with the invention includes those described in Meathrel, et al., U.S. Pat. No. 7,727,466, entitled “Disintegratable films for diagnostic devices,” granted on Jun. 1, 2010.

“Droplet operation” means any manipulation of a droplet on a droplet actuator. A droplet operation may, for example, include: loading a droplet into the droplet actuator; dispensing one or more droplets from a source droplet; splitting, separating or dividing a droplet into two or more droplets; transporting a droplet from one location to another in any direction; merging or combining two or more droplets into a single droplet; diluting a droplet; mixing a droplet; agitating a droplet; deforming a droplet; retaining a droplet in position; incubating a droplet; heating a droplet; vaporizing a droplet; cooling a droplet; disposing of a droplet; transporting a droplet out of a droplet actuator; other droplet operations described herein; and/or any combination of the foregoing. The terms “merge,” “merging,” “combine,” “combining” and the like are used to describe the creation of one droplet from two or more droplets. It should be understood that when such a term is used in reference to two or more droplets, any combination of droplet operations that are sufficient to result in the combination of the two or more droplets into one droplet may be used. For example, “merging droplet A with droplet B,” can be achieved by transporting droplet A into contact with a stationary droplet B, transporting droplet B into contact with a stationary droplet A, or transporting droplets A and B into contact with each other. The terms “splitting,” “separating” and “dividing” are not intended to imply any particular outcome with respect to volume of the resulting droplets (i.e., the volume of the resulting droplets can be the same or different) or number of resulting droplets (the number of resulting droplets may be 2, 3, 4, 5 or more). The term “mixing” refers to droplet operations which result in more homogenous distribution of one or more components within a droplet. Examples of “loading” droplet operations include microdialysis loading, pressure assisted loading, robotic loading, passive loading, and pipette loading. Droplet operations may be electrode-mediated. In some cases, droplet operations are further facilitated by the use of hydrophilic and/or hydrophobic regions on surfaces and/or by physical obstacles. For examples of droplet operations, see the patents and patent applications cited above under the definition of “droplet actuator.” Impedance or capacitance sensing or imaging techniques may sometimes be used to determine or confirm the outcome of a droplet operation. Examples of such techniques are described in Sturmer et al., U.S. Patent Application Publication No. US20100194408, entitled “Capacitance Detection in a Droplet Actuator,” published on Aug. 5, 2010, the entire disclosure of which is incorporated herein by reference. Generally speaking, the sensing or imaging techniques may be used to confirm the presence or absence of a droplet at a specific electrode. For example, the presence of a dispensed droplet at the destination electrode following a droplet dispensing operation confirms that the droplet dispensing operation was effective. Similarly, the presence of a droplet at a detection spot at an appropriate step in an assay protocol may confirm that a previous set of droplet operations has successfully produced a droplet for detection. Droplet transport time can be quite fast. For example, in various embodiments, transport of a droplet from one electrode to the next may exceed about 1 sec, or about 0.1 sec, or about 0.01 sec, or about 0.001 sec. In one embodiment, the electrode is operated in AC mode but is switched to DC mode for imaging. It is helpful for conducting droplet operations for the footprint area of droplet to be similar to electrowetting area; in other words, 1x-, 2x- 3x-droplets are usefully controlled operated using 1, 2, and 3 electrodes, respectively. If the droplet footprint is greater than the number of electrodes available for conducting a droplet operation at a given time, the difference between the droplet size and the number of electrodes should typically not be greater than 1; in other words, a 2x droplet is usefully controlled using 1 electrode and a 3x droplet is usefully controlled using 2 electrodes. When droplets include beads, it is useful for droplet size to be equal to the number of electrodes controlling the droplet, e.g., transporting the droplet.

“Filler fluid” means a fluid associated with a droplet operations substrate of a droplet actuator, which fluid is sufficiently immiscible with a droplet phase to render the droplet phase subject to electrode-mediated droplet operations. For example, the droplet operations gap of a droplet actuator is typically filled with a filler fluid. The filler fluid may, for example, be or include a low-viscosity oil, such as silicone oil or hexadecane filler fluid. The filler fluid may be or include a halogenated oil, such as a fluorinated or perfluorinated oil. The filler fluid may fill the entire gap of the droplet actuator or may coat one or more surfaces of the droplet actuator. Filler fluids may be conductive or non-conductive. Filler fluids may be selected to improve droplet operations and/or reduce loss of reagent or target substances from droplets, improve formation of microdroplets, reduce cross contamination between droplets, reduce contamination of droplet actuator surfaces, reduce degradation of droplet actuator materials, etc. For example, filler fluids may be selected for compatibility with droplet actuator materials. As an example, fluorinated filler fluids may be usefully employed with fluorinated surface coatings. Fluorinated filler fluids are useful to reduce loss of lipophilic compounds, such as umbelliferone substrates like 6-hexadecanoylamido-4-methylumbelliferone substrates (e.g., for use in Krabbe, Niemann-Pick, or other assays); other umbelliferone substrates are described in U.S. Patent Pub. No. 20110118132, published on May 19, 2011, the entire disclosure of which is incorporated herein by reference. Examples of suitable fluorinated oils include those in the Galden line, such as Galden HT170 (bp=170° C., viscosity=1.8 cSt, density=1.77), Galden HT200 (bp=200 C, viscosity=2.4 cSt, d=1.79), Galden HT230 (bp=230 C, viscosity=4.4 cSt, d=1.82) (all from Solvay Solexis); those in the Novec line, such as Novec 7500 (bp=128 C, viscosity=0.8 cSt, d=1.61), Fluorinert FC-40 (bp=155° C., viscosity=1.8 cSt, d=1.85), Fluorinert FC-43 (bp=174° C., viscosity=2.5 cSt, d=1.86) (both from 3M). In general, selection of perfluorinated filler fluids is based on kinematic viscosity (<7 cSt is preferred, but not required), and on boiling point (>150° C. is preferred, but not required, for use in DNA/RNA-based applications (PCR, etc.)). Filler fluids may, for example, be doped with surfactants or other additives. For example, additives may be selected to improve droplet operations and/or reduce loss of reagent or target substances from droplets, formation of microdroplets, cross contamination between droplets, contamination of droplet actuator surfaces, degradation of droplet actuator materials, etc. Composition of the filler fluid, including surfactant doping, may be selected for performance with reagents used in the specific assay protocols and effective interaction or non-interaction with droplet actuator materials. Examples of filler fluids and filler fluid formulations suitable for use with the invention are provided in Srinivasan et al, International Patent Pub. Nos. WO/2010/027894, entitled “Droplet Actuators, Modified Fluids and Methods,” published on Mar. 11, 2010, and WO/2009/021173, entitled “Use of Additives for Enhancing Droplet Operations,” published on Feb. 12, 2009; Sista et al., International Patent Pub. No. WO/2008/098236, entitled “Droplet Actuator Devices and Methods Employing Magnetic Beads,” published on Aug. 14, 2008; and Monroe et al., U.S. Patent Publication No. 20080283414, entitled “Electrowetting Devices,” filed on May 17, 2007; the entire disclosures of which are incorporated herein by reference, as well as the other patents and patent applications cited herein. Fluorinated oils may in some cases be doped with fluorinated surfactants, e.g., Zonyl FSO-100 (Sigma-Aldrich) and/or others.

“Immobilize” with respect to magnetically responsive beads, means that the beads are substantially restrained in position in a droplet or in filler fluid on a droplet actuator. For example, in one embodiment, immobilized beads are sufficiently restrained in position in a droplet to permit execution of a droplet splitting operation, yielding one droplet with substantially all of the beads and one droplet substantially lacking in the beads.

“Magnetically responsive” means responsive to a magnetic field. “Magnetically responsive beads” include or are composed of magnetically responsive materials. Examples of magnetically responsive materials include paramagnetic materials, ferromagnetic materials, ferrimagnetic materials, and metamagnetic materials. Examples of suitable paramagnetic materials include iron, nickel, and cobalt, as well as metal oxides, such as Fe3O4, BaFe12O19, CoO, NiO, Mn2O3, Cr2O3, and CoMnP.

“Reservoir” means an enclosure or partial enclosure configured for holding, storing, or supplying liquid. A droplet actuator system of the invention may include on-cartridge reservoirs and/or off-cartridge reservoirs. On-cartridge reservoirs may be (1) on-actuator reservoirs, which are reservoirs in the droplet operations gap or on the droplet operations surface; (2) off-actuator reservoirs, which are reservoirs on the droplet actuator cartridge, but outside the droplet operations gap, and not in contact with the droplet operations surface; or (3) hybrid reservoirs which have on-actuator regions and off-actuator regions. An example of an off-actuator reservoir is a reservoir in the top substrate. An off-actuator reservoir is typically in fluid communication with an opening or flow path arranged for flowing liquid from the off-actuator reservoir into the droplet operations gap, such as into an on-actuator reservoir. An off-cartridge reservoir may be a reservoir that is not part of the droplet actuator cartridge at all, but which flows liquid to some portion of the droplet actuator cartridge. For example, an off-cartridge reservoir may be part of a system or docking station to which the droplet actuator cartridge is coupled during operation. Similarly, an off-cartridge reservoir may be a reagent storage container or syringe which is used to force fluid into an on-cartridge reservoir or into a droplet operations gap. A system using an off-cartridge reservoir will typically include a fluid passage means whereby liquid may be transferred from the off-cartridge reservoir into an on-cartridge reservoir or into a droplet operations gap.

“Transporting into the magnetic field of a magnet,” “transporting towards a magnet,” and the like, as used herein to refer to droplets and/or magnetically responsive beads within droplets, is intended to refer to transporting into a region of a magnetic field capable of substantially attracting magnetically responsive beads in the droplet. Similarly, “transporting away from a magnet or magnetic field,” “transporting out of the magnetic field of a magnet,” and the like, as used herein to refer to droplets and/or magnetically responsive beads within droplets, is intended to refer to transporting away from a region of a magnetic field capable of substantially attracting magnetically responsive beads in the droplet, whether or not the droplet or magnetically responsive beads is completely removed from the magnetic field. It will be appreciated that in any of such cases described herein, the droplet may be transported towards or away from the desired region of the magnetic field, and/or the desired region of the magnetic field may be moved towards or away from the droplet. Reference to an electrode, a droplet, or magnetically responsive beads being “within” or “in” a magnetic field, or the like, is intended to describe a situation in which the electrode is situated in a manner which permits the electrode to transport a droplet into and/or away from a desired region of a magnetic field, or the droplet or magnetically responsive beads is/are situated in a desired region of the magnetic field, in each case where the magnetic field in the desired region is capable of substantially attracting any magnetically responsive beads in the droplet. Similarly, reference to an electrode, a droplet, or magnetically responsive beads being “outside of” or “away from” a magnetic field, and the like, is intended to describe a situation in which the electrode is situated in a manner which permits the electrode to transport a droplet away from a certain region of a magnetic field, or the droplet or magnetically responsive beads is/are situated away from a certain region of the magnetic field, in each case where the magnetic field in such region is not capable of substantially attracting any magnetically responsive beads in the droplet or in which any remaining attraction does not eliminate the effectiveness of droplet operations conducted in the region. In various aspects of the invention, a system, a droplet actuator, or another component of a system may include a magnet, such as one or more permanent magnets (e.g., a single cylindrical or bar magnet or an array of such magnets, such as a Halbach array) or an electromagnet or array of electromagnets, to form a magnetic field for interacting with magnetically responsive beads or other components on chip. Such interactions may, for example, include substantially immobilizing or restraining movement or flow of magnetically responsive beads during storage or in a droplet during a droplet operation or pulling magnetically responsive beads out of a droplet.

“Washing” with respect to washing a bead means reducing the amount and/or concentration of one or more substances in contact with the bead or exposed to the bead from a droplet in contact with the bead. The reduction in the amount and/or concentration of the substance may be partial, substantially complete, or even complete. The substance may be any of a wide variety of substances; examples include target substances for further analysis, and unwanted substances, such as components of a sample, contaminants, and/or excess reagent. In some embodiments, a washing operation begins with a starting droplet in contact with a magnetically responsive bead, where the droplet includes an initial amount and initial concentration of a substance. The washing operation may proceed using a variety of droplet operations. The washing operation may yield a droplet including the magnetically responsive bead, where the droplet has a total amount and/or concentration of the substance which is less than the initial amount and/or concentration of the substance. Examples of suitable washing techniques are described in Pamula et al., U.S. Pat. No. 7,439,014, entitled “Droplet-Based Surface Modification and Washing,” granted on Oct. 21, 2008, the entire disclosure of which is incorporated herein by reference.

The terms “top,” “bottom,” “over,” “under,” and “on” are used throughout the description with reference to the relative positions of components of the droplet actuator, such as relative positions of top and bottom substrates of the droplet actuator. It will be appreciated that the droplet actuator is functional regardless of its orientation in space.

When a liquid in any form (e.g., a droplet or a continuous body, whether moving or stationary) is described as being “on”, “at”, or “over” an electrode, array, matrix or surface, such liquid could be either in direct contact with the electrode/array/matrix/surface, or could be in contact with one or more layers or films that are interposed between the liquid and the electrode/array/matrix/surface. In one embodiment, filler fluid can be considered as a film between such liquid and the electrode/array/matrix/surface.

When a droplet is described as being “on” or “loaded on” a droplet actuator, it should be understood that the droplet is arranged on the droplet actuator in a manner which facilitates using the droplet actuator to conduct one or more droplet operations on the droplet, the droplet is arranged on the droplet actuator in a manner which facilitates sensing of a property of or a signal from the droplet, and/or the droplet has been subjected to a droplet operation on the droplet actuator.

### 7 DESCRIPTION

The present invention provides methods of on-actuator temperature measurement and temperature control. In some embodiments, temperature sensors are provided that are formed of wiring traces laid out in a defined shape or geometric pattern. In other embodiments, one or more of the temperature sensors are combined with one or more heaters that are formed of wiring traces. In another embodiment, heaters are provided that are designed for one-to-one correspondence to the temperature sensors to form temperature sensor-heater pairs.

In further embodiments, the temperature sensors comprise a connection comprising a plurality of terminals by which an amount of current can be applied and then a voltage measured, wherein the voltage that is measured across the temperature sensors can be accurately correlated to a temperature. In one embodiment, the temperature sensors comprise a 4-terminal Kelvin connection. In other embodiments, a first temperature sensor comprising a 4-terminal Kelvin connection is combined with one or more additional temperature sensors, wherein each of the one or more additional temperature sensors comprise a 2-terminal connection (e.g., wherein the current runs in series through the first temperature sensor and the one or more additional temperature sensors, or wherein the one or more additional temperature sensors share the same net). In another embodiment, one or more of the temperature sensors and one or more of the heaters are formed from the same wiring trace.

### 7.1 Measuring Small Resistances

### 7.1.1 Four Wire Measurement

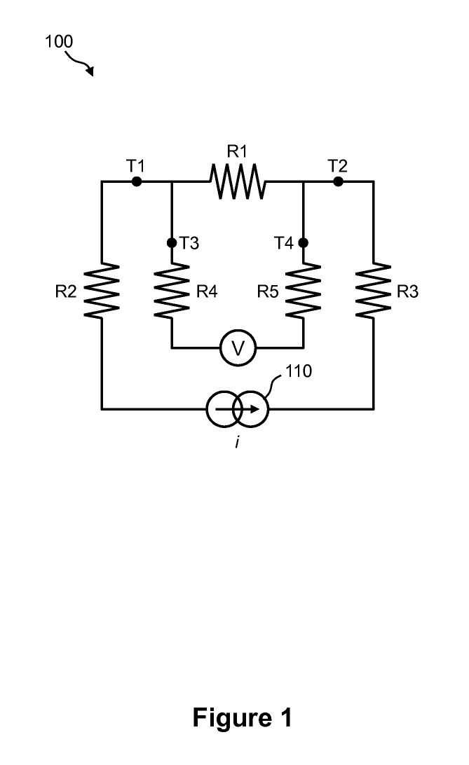

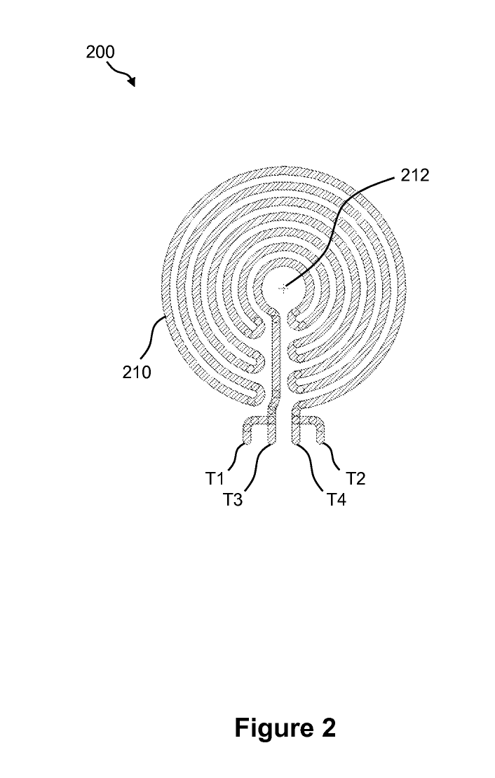

FIG. 1 illustrates a schematic diagram of a Kelvin electrical connection 100, which is well known. Each of the presently disclosed temperature sensors that are described below with reference to FIGS. 2 through 8 are implemented as a wiring trace on a printed circuit board (PCB), wherein the wiring trace includes a Kelvin connection, such as Kelvin electrical connection 100. Kelvin electrical connection 100 includes a resistor R1 that represents the resistance of the presently disclosed temperature sensors. Resistor R1 is arranged between a terminal T1 and a terminal T2, which are the current terminals. Resistor R1 is also arranged between a terminal T3 and a terminal T4, which are the sense terminals. The current terminals T1 and T2 are driven by a current source 110, which provides a known amount of current, and which may include a constant current source. Certain parasitic resistances (e.g., represented by resistors R2 and R3) are present in the loop that contains resistor R1 and current source 110.

When current source 110 is supplying a current through resistor R1, a voltage V can be measured across resistor R1 at current sense T3 and T4. Certain parasitic resistances (e.g., represented by resistors R4 and R5) are present in the loop that contains resistor R1 and voltage V.

The measurement of small resistances is quite common and is well documented. As shown in FIG. 1, a typical scenario is to provide a known current, and measure the voltage across the unknown resistance. A four wire (or terminal) measurement system allows the measurement to include only what is desired (for example, excluding lead resistance).

Examples of temperature sensors that include Kelvin electrical connections are described below with reference to FIGS. 2, 3, 4, 5, and 6A, wherein a constant current is applied, then the voltage V is measured, and then the voltage V is correlated to a temperature.

### 7.1.2 Self Heating

Current through a resistive load will dissipate power in that load, and will raise its temperature. In order to use the measurement of resistance to infer temperature, there should be some consideration of or compensation for this self heating to avoid excessive error. In one embodiment, compensation for this self heating comprises preventing the maximum power dissipation from raising the temperature of the sense trace by more than 0.1° C. For example, using Newton's Law of cooling, an appropriate power dissipation can be chosen that does not cause excessive heating.

In some embodiments, pulsed measurements are possible in order to reduce self heating. However, where the thermal time constant of the sense traces are very small (for example, as described below with reference to FIGS. 2, 3, 4, 5, and 6A), measurement precision can be improved by oversampling using continuous measurement.

### 7.1.3 Thermal EMF

The presence of different materials in a temperature gradient is expected to create a thermal electromotive force (EMF). This thermal EMF is expected to be part of the voltage measurement unless measures are taken to exclude it. Examples of standard methods to exclude thermal EMF include, but are not limited to, the following:
1. Offset Compensation: measure with current both on and off and subtract voltage measurements;
2. Current Reversal: reverse current and expect the thermal voltage to remain constant in magnitude and polarity;
3. Delta: sample voltage with 3 different currents to get 2 delta measurements, one with a positive change and another with a negative change (this method compensates for linearly changing thermal voltage); and
4. Lock-in: modulate excitation current, sample voltage and demodulate (in software or analog hardware) such that there is phase and frequency selectivity. The “lock-in” method is useful because the signal selectivity afforded by this method and similar modulation/demodulation techniques allows for smaller sensors, and better excludes signal interference from electrowetting AC mode and other sources.

### 7.2 Temperature Sensors and Heaters

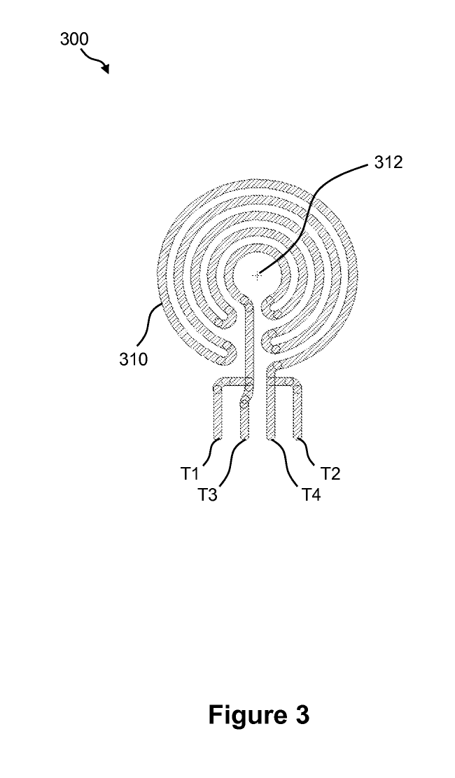

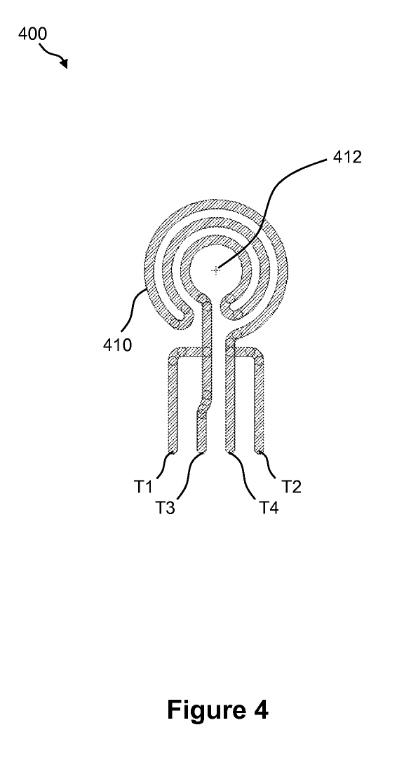

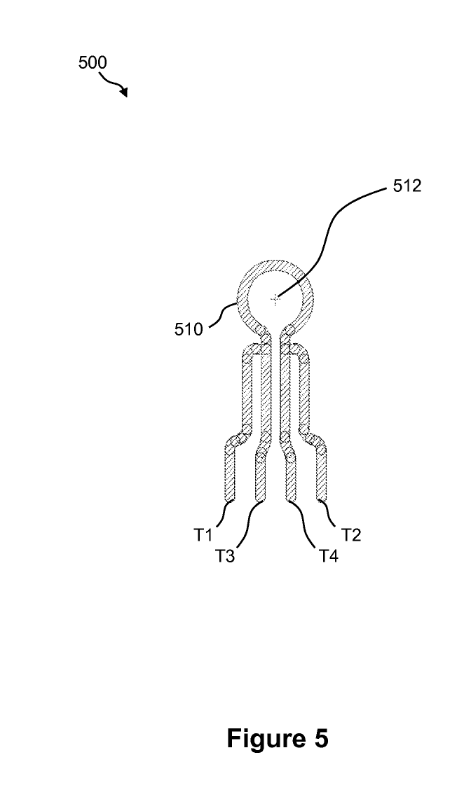

FIGS. 2, 3, 4, and 5 illustrate plan views of four examples, respectively, of temperature sensors formed of wiring traces laid out in circular patterns. Specifically, FIG. 2 shows a 7-loop temperature sensor 200, FIG. 3 shows a 5-loop temperature sensor 300, FIG. 4 shows a 3-loop temperature sensor 400, and FIG. 5 shows a 1-loop temperature sensor 500. The 7-loop temperature sensor 200, the 5-loop temperature sensor 300, the 3-loop temperature sensor 400, and the 1-loop temperature sensor 500 each include a 4-terminal Kelvin connection for measuring a voltage and inferring a temperature.

The 7-loop temperature sensor 200 shown in FIG. 2 is formed of a wiring trace 210. The wiring trace 210 is a continuous wiring trace that runs in serpentine fashion to form seven concentric circles about a center point 212. Correlating 7-loop temperature sensor 200 to Kelvin electrical connection 100 of FIG. 1, terminals T1 and T3 are at one end of wiring trace 210 and terminals T2 and T4 are at the other end of wiring trace 210, whereas the wiring trace 210 itself corresponds to resistor R1 of Kelvin electrical connection 100.

The 5-loop temperature sensor 300 shown in FIG. 3 is formed of a wiring trace 310. The wiring trace 310 is a continuous wiring trace that runs in serpentine fashion to form five concentric circles about a center point 312. Correlating 5-loop temperature sensor 300 to Kelvin electrical connection 100 of FIG. 1, terminals T1 and T3 are at one end of wiring trace 310 and terminals T2 and T4 are at the other end of wiring trace 310, whereas the wiring trace 310 itself corresponds to resistor R1 of Kelvin electrical connection 100.

The 3-loop temperature sensor 400 shown in FIG. 4 is formed of a wiring trace 410. The wiring trace 410 is a continuous wiring trace that runs in serpentine fashion to form three concentric circles about a center point 412. Correlating 3-loop temperature sensor 400 to Kelvin electrical connection 100 of FIG. 1, terminals T1 and T3 are at one end of wiring trace 410 and terminals T2 and T4 are at the other end of wiring trace 410, whereas the wiring trace 410 itself corresponds to resistor R1 of Kelvin electrical connection 100.

The 1-loop temperature sensor 500 shown in FIG. 5 is formed of a wiring trace 510. The wiring trace 510 is a continuous wiring trace that runs in serpentine fashion to form one circle about a center point 512. Correlating 1-loop temperature sensor 500 to Kelvin electrical connection 100 of FIG. 1, terminals T1 and T3 are at one end of wiring trace 510 and terminals T2 and T4 are at the other end of wiring trace 510, whereas the wiring trace 510 itself corresponds to resistor R1 of Kelvin electrical connection 100.

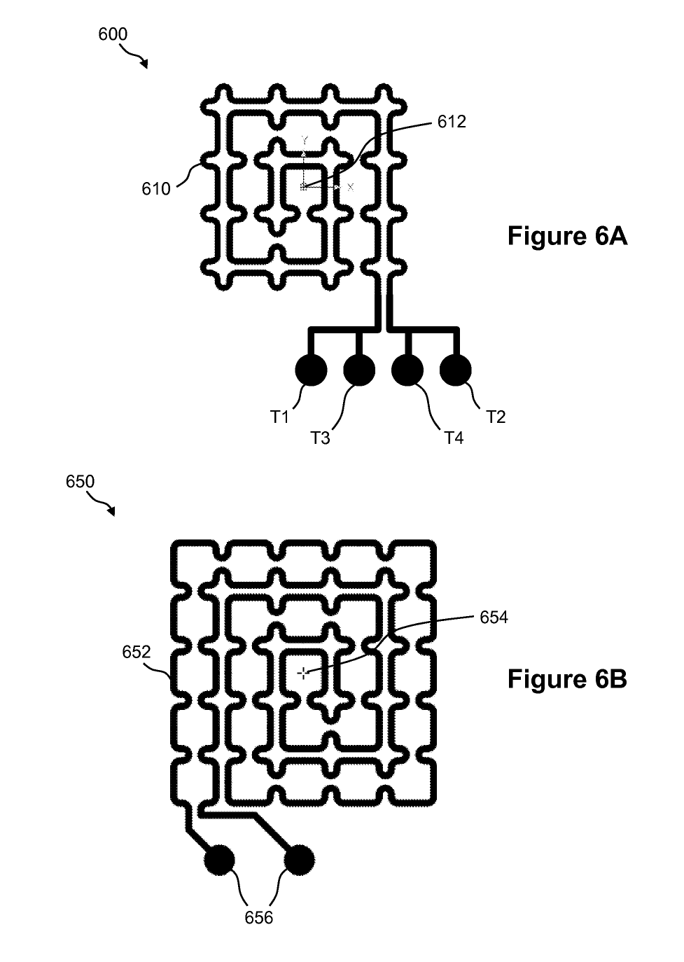

FIGS. 6A and 6B show a temperature sensor-heater pair. In particular, FIG. 6A illustrates a plan view of another example of a temperature sensor 600 that includes a 4-terminal Kelvin connection. FIG. 6B illustrates a plan view of a heater 650 whose geometry and size is designed to correspond to the geometry and size of temperature sensor 600.

Referring now to FIG. 6A, temperature sensor 600 is formed of a wiring trace 610 that is laid out in a substantially square pattern. For example, the wiring trace 610 is a continuous wiring trace that runs in serpentine fashion to form concentric squares about a center point 612. Correlating temperature sensor 600 to Kelvin electrical connection 100 of FIG. 1, terminals T1 and T3 are at one end of wiring trace 610 and terminals T2 and T4 are at the other end of wiring trace 610, whereas the wiring trace 610 itself corresponds to resistor R1 of Kelvin electrical connection 100.

7-loop temperature sensor 200 of FIG. 2, 5-loop temperature sensor 300 of FIG. 3, 3-loop temperature sensor 400 of FIG. 4, 1-loop temperature sensor 500 of FIG. 5, and temperature sensor 600 of FIG. 6A are “on-actuator temperature sensors.” By “on-actuator temperature sensor” is meant a temperature sensor that is a part of (i.e., not separate from) a droplet actuator, for example, a temperature sensor that is built into the bottom substrate of a droplet actuator.

Referring now to FIG. 6B, heater 650 is formed of a wiring trace 652 that is laid out in a substantially square pattern. For example, the wiring trace 652 is a continuous wiring trace that runs in serpentine fashion to form concentric squares about a center point 654. A pair of terminals 656 provides electrical connection to heater 650. The layout of temperature sensor 600 and heater 650 can accommodate PCB substrates (not shown) in the spaces within and/or around the wiring trace 610 and wiring trace 652, respectively. The overall area of heater 650 may be larger than the overall area of temperature sensor 600. In one embodiment, heater 650 covers an area of about 5.5 mm by about 5.5 mm, whereas temperature sensor 600 covers an area of about 4.375 mm by about 4.375 mm. Heater 650 is an “on-actuator heater.” By “on-actuator heater” is meant a heater that is a part of (i.e., not separate from) a droplet actuator, for example, a heater that is built into the bottom substrate of a droplet actuator.

Referring now to FIGS. 2, 3, 4, 5, and 6A, wiring trace 210 of 7-loop temperature sensor 200, wiring trace 310 of 5-loop temperature sensor 300, wiring trace 410 of 3-loop temperature sensor 400, wiring trace 510 of 1-loop temperature sensor 500, and wiring trace 610 of temperature sensor 600 can be formed of copper, for example ½-ounce copper. In one embodiment, the thickness is about 17 μm, the width is about 125 μm, the length is about 49.65 mm, the resistance R is about 0.402 ohms at about 20° C., the sensitivity is about 54 μV/° C., and the alpha (α) is about 0.00384, where alpha (α) is the temperature coefficient (per ° C.). In another embodiment, the resistance R is about 0.485 ohms at about −10° C. and about 0.759 ohms at about 120° C. In another embodiment, the resistance R is about 0.548 ohms at about 20° C. and the measured alpha (α) is about 0.0038537.

Referring again to FIG. 6B, wiring trace 652 of heater 650 can be formed of copper, for example ½-ounce copper. In one embodiment, the thickness is about 17 μm, the width is about 125 μm, the length is about 76.88 mm, and the resistance R is about 0.623 ohms at about 20° C. In one embodiment, the resistance R is about 0.551 ohms at about −10° C. and about 0.862 ohms at about 120° C.

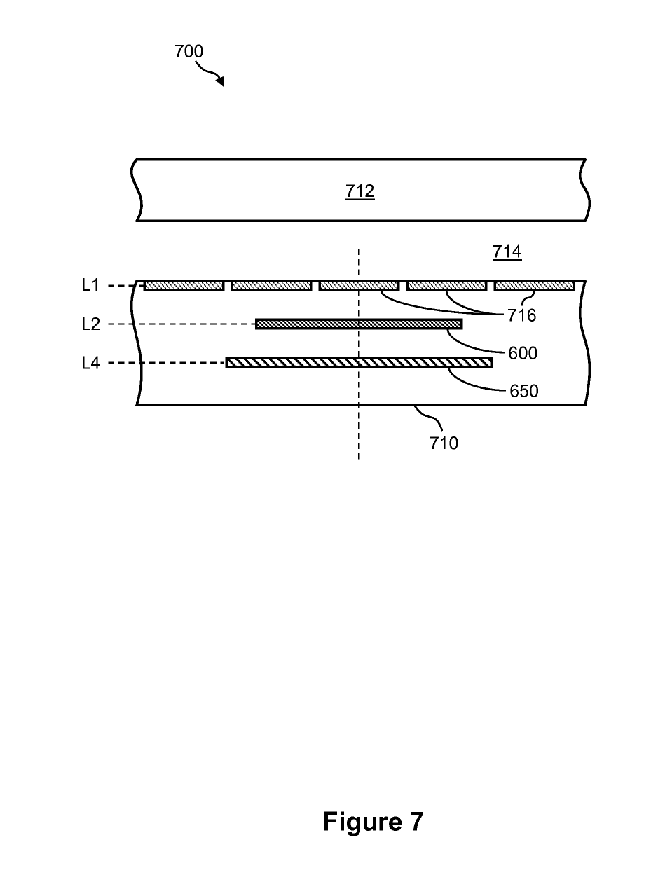

Temperature sensor 600 and heater 650 are designed to be substantially aligned in a droplet actuator, albeit on different layers of, for example, the bottom substrate of a droplet actuator. For example, FIG. 7 illustrates a cross-sectional view of a portion of a droplet actuator 700 and shows an example of a PCB layer stack that includes an electrode layer, a temperature sensor layer, and a heater layer. Droplet actuator 700 includes a bottom substrate 710 and a top substrate 712 that are separated by a droplet operations gap 714. Bottom substrate 710 may include an arrangement of droplet operations electrodes 716 (e.g., electrowetting electrodes). Droplet operations are conducted atop droplet operations electrodes 716 on a droplet operations surface.

In one embodiment, bottom substrate 710 is a multi-layer PCB that includes an arrangement of signal, power, and ground layers. For example, the droplet operations electrodes 716 are formed on a layer 1 (layer L1), temperature sensor 600 of FIG. 6A is formed on a layer 2 (layer L2), and heater 650 of FIG. 6B is formed on a layer 4 (layer L4). Other intermediate layers are not shown. Temperature sensor 600 on layer L2 and heater 650 on layer L4 are substantially aligned with a certain droplet operations electrode 716 on layer L1. Temperature sensor 600 is on a PCB layer that is closest to the droplet operations electrode 716 in order to most accurately measure the temperature at the droplet operations electrode 716 during droplet operations.

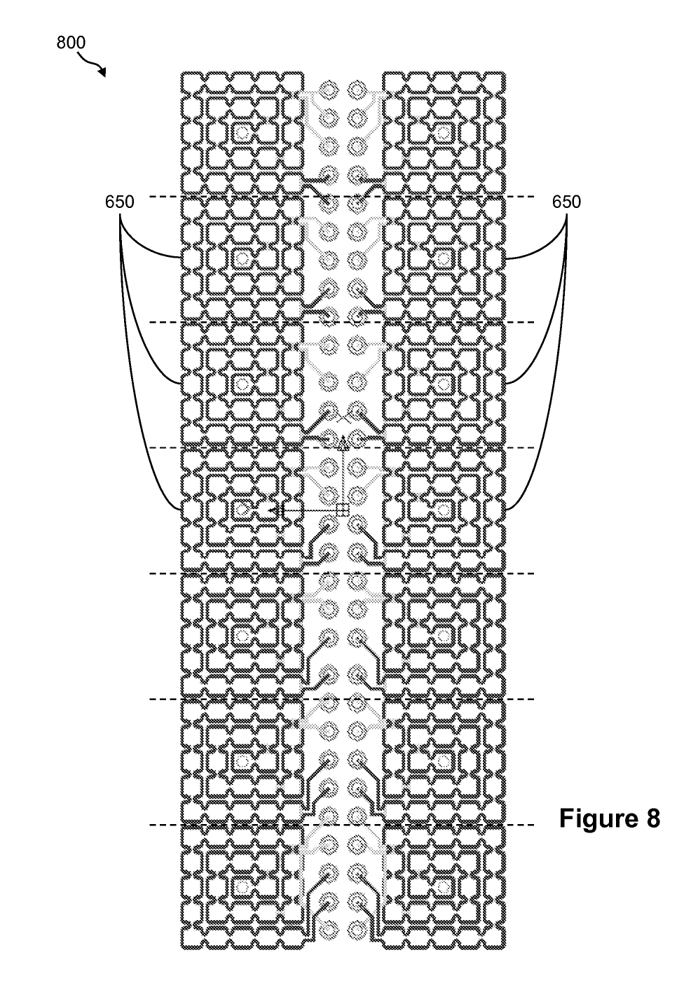

In another embodiment, one or more of the temperature sensors are combined with one or more heaters in an array on a droplet actuator. In one embodiment, heaters are provided that are designed for one-to-one correspondence to the temperature sensors to form temperature sensor-heater pairs. In another embodiment, an array of temperature sensor-heater pairs can be provided on a droplet actuator. For example, FIG. 8 illustrates a plan view of an array 800 of heaters 650. Each of the heaters 650 has a corresponding temperature sensor 600 (not visible). Further, the one or more temperature sensors and one or more heaters, including temperature sensor-heater pairs, can be any defined shape or geometric pattern, including but not limited to, to linear, circular, ovular or elliptical, square, rectangular, triangular, hexagonal, spiral, fractal, and the like.

In some embodiments the wiring traces of the temperature sensors and the wiring traces of the heaters can be formed of copper, particularly ½-ounce copper in order to be more readily fabricated by conventional PCB processes. However, in other embodiments, the wiring traces of the temperature sensors can be formed of any material that is suitably resistive and with a sufficient temperature coefficient or characteristic to enable measurement of resistance and inference of temperature. In further embodiments, the wiring traces of the heaters can be formed of any suitably resistive material, for example a material that is more resistive than copper. Without being bound by theory, it is thought that by utilizing a material more resistive than copper to form the wiring traces of the heaters, a lower current is required for the same heating power, which makes connector specification easier and simplifies integration and electrical routing of the cartridge (i.e., no high current and potentially high power dissipation traces are required). Examples of materials more resistive than copper that may be used to form the wiring traces of the heaters include nickel phosphorus (NiP) alloys such as OhmegaPly®, nickel chromium (NiCr) alloys such as Nichrome, nickel chromium aluminum silicon (NCAS), chromium silicon monoxide (CrSiO), carbon based inks, and the like.

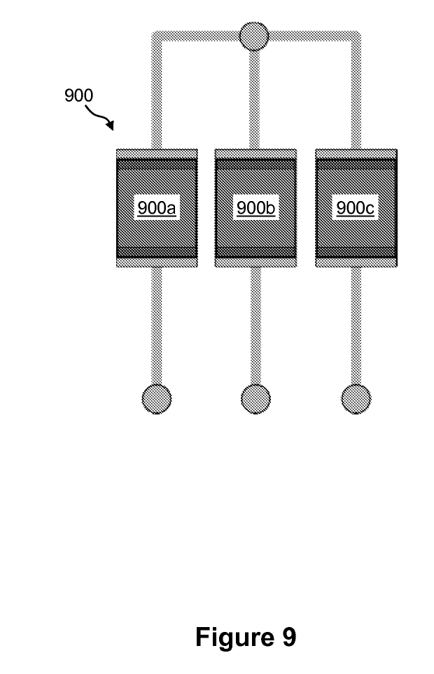

For example, FIG. 9 illustrates a plan view of an example of a set of non-copper heaters 900. For example, FIG. 9 shows a non-copper heater 900a, a non-copper heater 900b, and a non-copper heater 900c. One side of the non-copper heaters 900a, 900b, and 900c are electrically connected in common, whereas the other sides of the non-copper heaters 900a, 900b, and 900c have separate electrical connections, as shown. Non-copper heaters 900 are formed of a material that has a higher sheet resistance than copper. For example, non-copper heaters 900 can be formed of NiP alloys or NiCr alloys. As a result, as compared with copper heaters, less current is needed for same amount of power, which allows larger structures.

A benefit of a lower current requirement is fewer droplet actuator I/O connections, as common nets can use the same connection (i.e., allows ganged connections). For example, the side of the non-copper heaters 900a, 900b, and 900c that are electrically connected in common can use the same connection. Another benefit of a lower current requirement is modularity. For example, for the connections to the non-copper heaters 900, low current can be routed in copper with low power loss (allowing thinner and narrower copper traces). This allows spatial separation between the connector and the non-copper heater because there is reduced power dissipation concern with routing. A benefit of larger structures is that they require less precision to fabricate and provide uniformity (i.e., less pattern non-uniformity).

In further embodiments, the temperature sensors comprise a connection comprising a plurality of terminals by which a known amount of current can be applied and then a voltage measured, wherein the voltage that is measured across the temperature sensors can be accurately correlated to a temperature. In one embodiment, the temperature sensors comprise a 4-terminal Kelvin connection. In other embodiments, a first temperature sensor comprising a 4-terminal Kelvin connection is combined with one or more additional temperature sensors, wherein each of the one or more additional temperature sensors comprise a 2-terminal connection (e.g., wherein the current runs in series through the first temperature sensor and the one or more additional temperature sensors, or wherein the one or more additional temperature sensors share the same net).

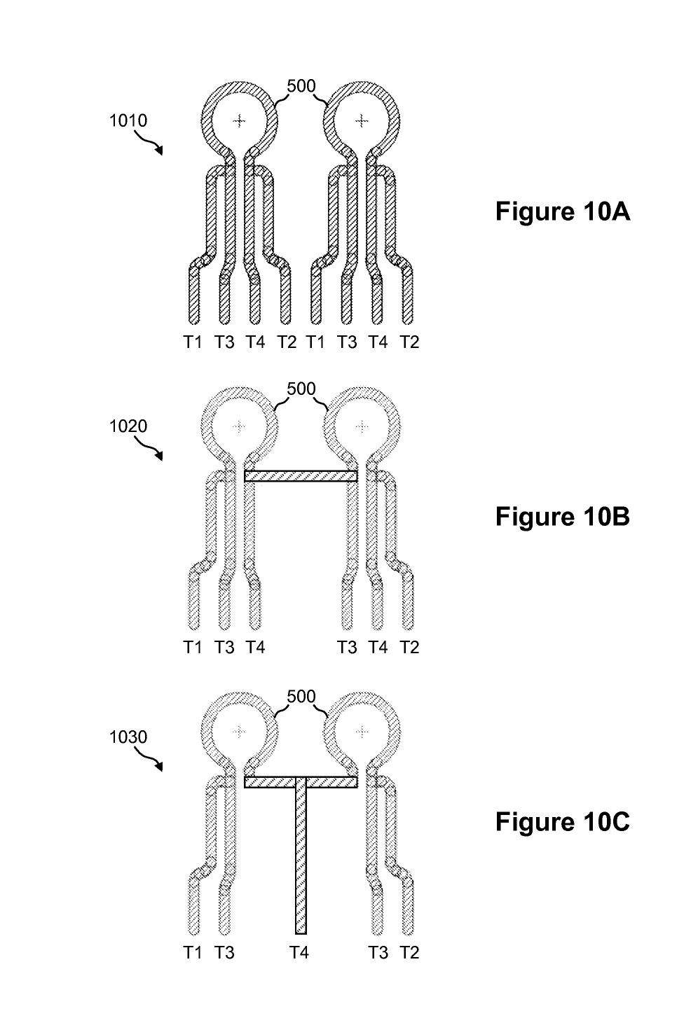

FIGS. 10A, 10B, and 10C illustrate plan views of examples of configuring the connections of the temperature sensor. By way of example, FIGS. 10A, 10B, and 10C show two instances of the 1-loop temperature sensor 500 of FIG. 5, which are arranged side-by-side. However, this is exemplary only. The configurations shown in FIGS. 10A, 10B, and 10C are applicable to any temperature sensors. Referring now to FIG. 10A, two of the 1-loop temperature sensors 500 are arranged side-by-side, wherein the excitation connections (T1, T2) and Kelvin connections (T3, T4) of the first 1-loop temperature sensor 500 are independent of the excitation connections (T1, T2) and Kelvin connections (T3, T4) of the second 1-loop temperature sensor 500. In this example, a total of eight droplet actuator I/O connections may be needed to support the two 1-loop temperature sensors 500.

Referring now to FIG. 10B, again two of the 1-loop temperature sensors 500 are arranged side-by-side. In this example, the excitation connections (T1, T2) are shared between the first and second 1-loop temperature sensors 500, while the Kelvin connections (T3, T4) of the first 1-loop temperature sensor 500 remain independent of the Kelvin connections (T3, T4) of the second 1-loop temperature sensor 500. In this example, a total of six droplet actuator I/O connections may be needed to support the two 1-loop temperature sensors 500, which is a savings of two I/O connections as compared with the configuration shown in FIG. 10A.

Referring now to FIG. 10C, again two of the 1-loop temperature sensors 500 are arranged side-by-side. In this example, the excitation connections (T1, T2) are shared between the first and second 1-loop temperature sensors 500, the Kelvin connection (T3) of the first 1-loop temperature sensor 500 is independent of the Kelvin connection (T3) of the second 1-loop temperature sensor 500, and the first and second 1-loop temperature sensors 500 share the Kelvin connection (T4), which serves as a common sense line. In this example, a total of five droplet actuator I/O connections may be needed to support the two 1-loop temperature sensors 500, which is a savings of three I/O connections as compared with the configuration shown in FIG. 10A.

The configurations shown in FIGS. 10B and 10C may be useful to conserve and/or reduce droplet actuator I/O connections when the droplet actuator comprises, for example, high-density arrays of temperature sensors.

In another embodiment, one or more of the temperature sensors and one or more of the heaters are formed from the same wiring trace. For example, instead of patterning a temperature sensor trace on one PCB layer and a heater trace on another PCB layer, a single trace on one PCB layer is used for both the temperature sensor and the heater. Then, the combination sensor/heater trace is controlled using an electronic multiplexing technique, such as a pulse-width modulation (PWM) technique. Preferably, the combination sensor/heater trace is patterned on a PCB layer that is close to the droplet operations electrode, such as on layer L2 of bottom substrate 710 of droplet actuator 700 of FIG. 7. The control signals to the combination sensor/heater trace are time multiplexed in two phases, one for heat generation and the second for temperature sensing. This multiplexing allows almost instantaneous feedback, which allows precise control of temperature at each zone on the droplet actuator.

The heat generation phase includes individual pulse width modulation power control on each heater element simultaneously in parallel. The temperature sensing phase includes sequentially scanning through each sensor element and measuring its resistance. The multiplexing cycle rate can be, for example, from about 1 ms to about 110 ms. In one example, a field-programmable gate array (FPGA) or a complex programmable logic device (CPLD) can create the multiplexing signal patterns under the control of a microcontroller. The microcontroller is then used to read the analog-to-digital (ADC) values, measuring the resistance of each element during the sense phase. The microcontroller performs any math transforms as necessary and then transmits the next PWM temperature set points to the FPGA or CPLD for creating the appropriate PWM widths for the next power phase. Cooling to remove excess heat could be performed by blowing chilled air at the appropriate areas of the droplet actuator. The combination sensor/heater trace requires (3×N)+1 electrical contact points (where N is the number of heater/sensor elements). Like the integrated heaters, such as heaters 650 of FIGS. 6B, 7, and 8, the combination sensor/heater trace allows the elimination of heater bars and provides more localized and accurate temperature control in the droplet actuator.

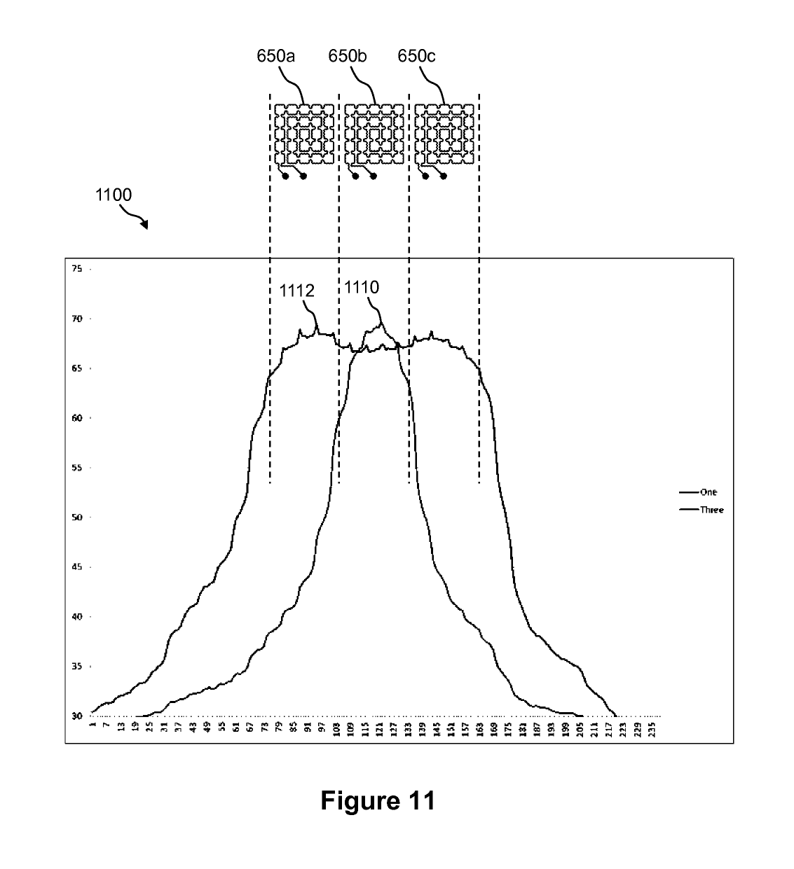

FIG. 11 shows an example of a set of individually controlled heaters 650 (see FIG. 8) in relation to a plot 1100 of heat profiles in the droplet actuator. Namely, FIG. 11 shows how multiple individually controlled heaters can be used to provide a controlled and uniform heating zone, i.e., to control heater “edge effects.” For example, FIG. 11 shows three heaters 650; namely, heaters 650a, 650b, and 650c. The heating profile tends to drop off sharply at the edges of a heating zone. If, for example, heater 650b is used alone, a heating profile curve 1110 shows a sharp thermal peak at heater 650b, which drops off sharply at the edges of heater 650b. However, an arrangement of multiple individually controlled heaters 650 can be used advantageously to control the heating profile to be more uniform in the heating zone of interest. For example, if heater 650b is the heating zone of interest, heaters 650a and 650c on either sides of heater 650b can be activated to provide a uniform heating profile at heater 650b. In this example, the thermal drop off is moved away from heater 650b to the edges of heaters 650a and 650c, as shown by a heating profile curve 1112. Accordingly, a substantially flat or uniform heating profile is present at the region of heater 650b.

A significant benefit of using multiple individually controlled heaters on a droplet actuator is that it allows for run-time reconfigurability. Currently, methods exist for designing heat flux density so as to achieve certain run-time goals (uniform temperature, certain thermal profile, etc). However, these methods do not allow run time reconfigurability to the degree that does a configuration of multiple individually controlled heaters, which pairs nicely with the run-time reconfigurability afforded by digital microfluidics.

### 7.3 Systems

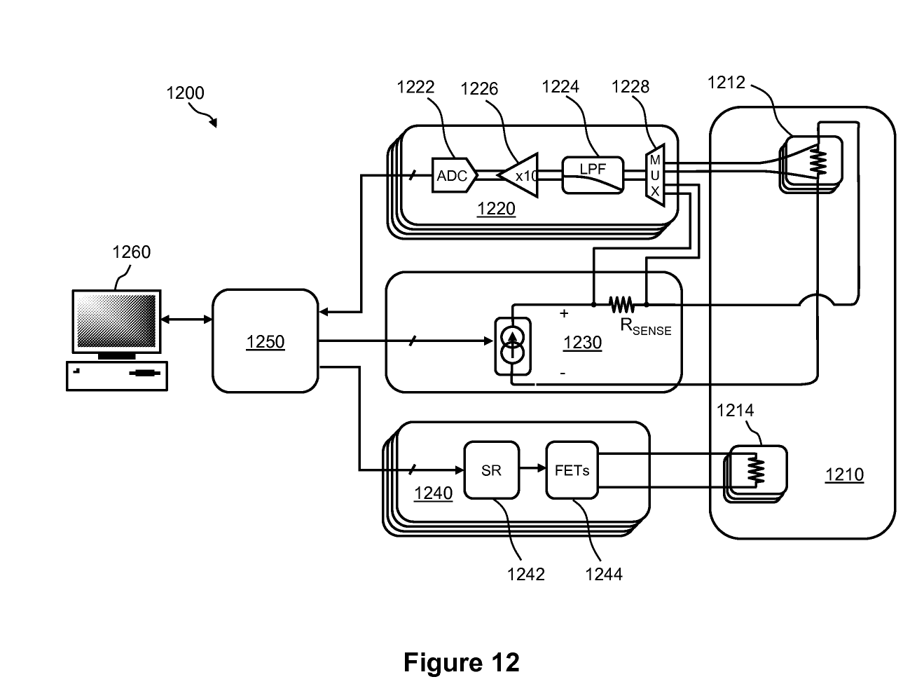

FIG. 12 illustrates a functional block diagram of an example of a microfluidics system 1200 that includes a droplet actuator 1210. Digital microfluidic technology conducts droplet operations on discrete droplets in a droplet actuator, such as droplet actuator 1210, by electrical control of their surface tension (electrowetting). The droplets may be sandwiched between two substrates of droplet actuator 1210, a bottom substrate and a top substrate separated by a droplet operations gap. The bottom substrate may include an arrangement of electrically addressable electrodes. The top substrate may include a reference electrode plane made, for example, from conductive ink or indium tin oxide (ITO). The bottom substrate and the top substrate may be coated with a hydrophobic material. Droplet operations are conducted in the droplet operations gap. The space around the droplets (i.e., the gap between bottom and top substrates) may be filled with an immiscible inert fluid, such as silicone oil, to prevent evaporation of the droplets and to facilitate their transport within the device. Other droplet operations may be effected by varying the patterns of voltage activation; examples include merging, splitting, mixing, and dispensing of droplets.

Additionally, droplet actuator 1210 includes one or more on-actuator temperature sensors and on-actuator heaters (i.e., one or more temperature sensor-heater pairs). For example, droplet actuator 1210 includes 72 temperature sensors 1212 and 72 heaters 1214, which form 72 temperature sensor-heater pairs. The 72 temperature sensors 1212 may be, for example, any combinations of 7-loop temperature sensors 200 of FIG. 2, 5-loop temperature sensors 300 of FIG. 3, 3-loop temperature sensors 400 of FIG. 4, 1-loop temperature sensors 500 of FIG. 5, and temperature sensors 600 of FIG. 6A. The 72 heaters 1214 can be, for example, 72 of the heaters 650 of FIG. 6B. Each of the 72 temperature sensors 1212 corresponds to one of the 72 heaters 1214. Therefore, a certain temperature sensor 1212 can be used to monitor the temperature at a certain location in droplet actuator 1210, which can be adjusted using its corresponding heater 1214.

Droplet actuator 1210 may be designed to fit onto an instrument deck (not shown) of microfluidics system 1200. The instrument deck may hold droplet actuator 1210 and house other droplet actuator features, such as, but not limited to one or more heating devices and one or more magnets (e.g., permanent magnets or electromagnets). Additionally, to support the 72 temperature sensors 1212 and the 72 heaters 1214 on droplet actuator 1210, the instrument deck may include multiple voltage measurement sensor boards 1220, a programmable current source 1230, and multiple heater control boards 1240.

In one embodiment, each of the multiple voltage measurement sensor boards 1220 includes an 8-channel analog-to-digital converter (ADC) 1222. For example, ADC 1222 supports 8 differential channels. Therefore, to support the 72 temperature sensors 1212, nine voltage measurement sensor boards 1220 are provided in microfluidics system 1200. In this example, each of the nine voltage measurement sensor boards 1220 is electrically connected to terminals T3 and T4 of nine temperature sensors 1212. More specifically, the terminals T3 and T4 of nine temperature sensors 1212 drive nine respective low-pass filters (LPFs) 1224, which then drive nine respective amplifiers 1226, which then drive the nine respective ADCs 1222. In one embodiment, the LPFs 1224 are about 77 kHz, single pole low-pass filters. In one embodiment, the amplifiers 1226 are op-amps that provide about 13× amplification. However, greater amplification is possible.

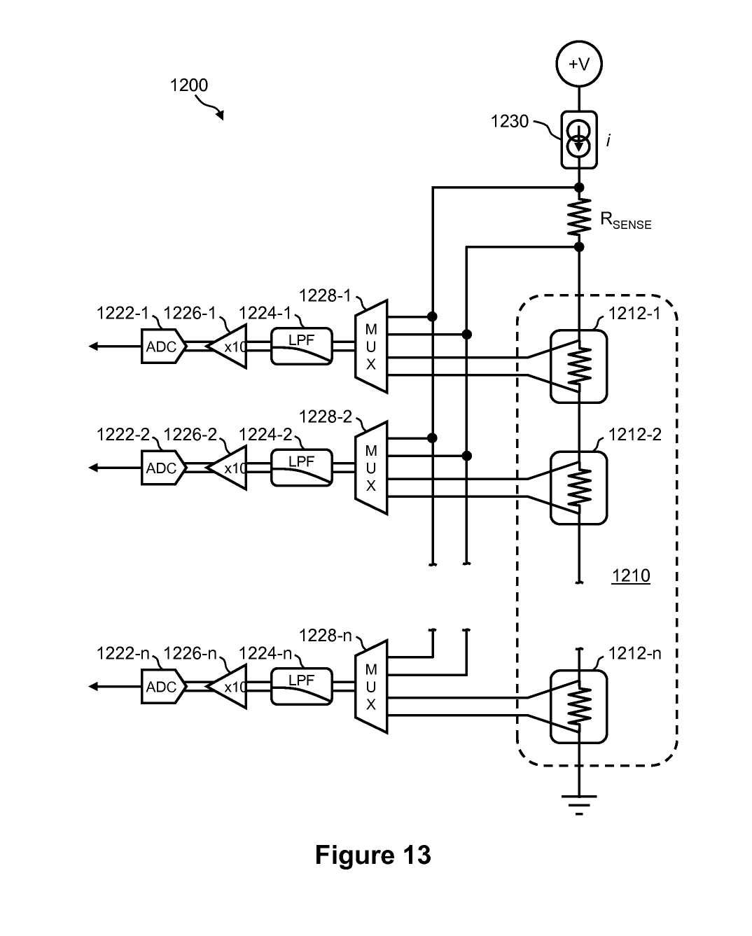

In one embodiment, programmable current source 1230 is a programmable current source that supplies all 72 of the temperature sensors 1212 on droplet actuator 1210. Programmable current source 1230 is, for example, a 0-200 mA constant current source that has 14-bit resolution and on/off or positive/negative modulation. In this example, programmable current source 1230 is electrically connected to terminals T1 and T2 of all 72 temperature sensors 1212. Additionally, a sense resistor R_{SENSE} is associated with programmable current source 1230. A multiplexer 1228 is provided at the input of each channel of the voltage measurement sensor boards 1220. Each of the multiplexers 1228 is used to select sense resistor R_{SENSE} during a calibration routine of microfluidics system 1200 for calibrating the temperature sensors 1212 of droplet actuator 1210. More details of the calibration portion of microfluidics system 1200 and droplet actuator 1210 are shown and described herein below with reference to FIG. 13.

In one embodiment, each of the multiple heater control boards 1240 supports 8 heaters 1214. Therefore, to support the 72 heaters 1214, nine heater control boards 1240 are provided in microfluidics system 1200. The input of each heater control board 1240 is, for example, a synchronous serial input that drives an SIPO (Serial In, Parallel Out) shift register 1242. On each heater control board 1240, the output of the SIPO shift register 1242 then drives 8 FET power switches 1244. On each heater control board 1240, the outputs of the 8 FET power switches 1244 then drive 8 of the heaters 1214 on droplet actuator 1210, wherein each heater 1214 can be individually controlled.

A controller 1250 of microfluidics system 1200 is electrically coupled to various hardware components of the invention, such as droplet actuator 1210, the multiple voltage measurement sensor boards 1220, programmable current source 1230, and the multiple heater control boards 1240. Controller 1250 controls the overall operation of microfluidics system 1200. Controller 1200 may, for example, be a general purpose computer, special purpose computer, personal computer, or other programmable data processing apparatus. Controller 1250 serves to provide processing capabilities, such as storing, interpreting, and/or executing software instructions, as well as controlling the overall operation of the system. Controller 1250 may be configured and programmed to control data and/or power aspects of these devices. For example, in one aspect, with respect to droplet actuator 1210, controller 1250 controls droplet manipulation by activating/deactivating electrodes. Optionally, controller 1250 can be in communication with a networked computer 1260. Networked computer 1260 can be, for example, any centralized server or cloud server.

In operation and under the control of controller 1250, programmable current source 1230 supplies a known amount of current to the temperature sensors 1212. Then, voltage measurement sensor boards 1220 are used to measure the voltage across each of the temperature sensors 1212. Then, the measured voltage from each of the temperature sensors 1212 can be correlated to a temperature. Then, if necessary, heater control boards 1240 are used to control the heaters 1214 and adjust the temperature at the droplet actuator 1210, whereas each heater 1214 can be controlled independently and the temperature across a large area of droplet actuator 1210 can be independently controlled, for example to hold substantially uniform or intentionally spatial or temporally varied temperatures.

More specifically, the offset compensation method is used to determine the resistance of temperature sensors 1212 and infer a temperature. In one embodiment, the 0.1° C.-self heating current has been determined to be about 35 mA. Therefore, programmable current source 1230 first supplies about +35 mA and a first set of voltage measurements are taken for all of the temperature sensors 1212. Then, programmable current source 1230 supplies about −35 mA and a second set of voltage measurements are taken. Then calculations are performed to determine the resistances of each of the temperature sensors 1212 and then each of the resistances is correlated to a temperature.

FIG. 13 illustrates a block diagram showing more details of the calibration portion of microfluidics system 1200 and droplet actuator 1210. For example, droplet actuator 1210 can include any number of sensors 1212. Accordingly, FIG. 13 shows temperature sensors 1212-1 through 1212-n, wherein the sense resistor R_{SENSE} and the temperature sensors 1212-1 through 1212-n are connected in series with the programmable current source 1230. The temperature sensors 1212-1 through 1212-n are connected to a first input of their respective multiplexers 1228-1 through 1228-n. While the one sense resistor R_{SENSE} is connected to a second input of all of the multiplexers 1228-1 through 1228-n.

During the calibration process, multiplexers 1228-1 through 1228-n are switched as necessary between selecting sense resistor R_{SENSE} and selecting the temperature sensors 1212-1 through 1212-n. However, when droplet actuator 1210 is in use, multiplexers 1228-1 through 1228-n are set to select the temperature sensors 1212-1 through 1212-n in order to read the temperature on droplet actuator 1210.

FIG. 13 shows that the calibration of the multiple temperature sensors 1212 of droplet actuator 1210 relies on the single sense resistor R_{SENSE}, which allows for a simple calibration process. Namely, no matter which temperature sensor 1212 is being calibrated, the excitation current passes through the one sense resistor R_{SENSE}. Further, sense resistor R_{SENSE} is being sensed by the same ADC 1222 that is sensing a particular temperature sensor 1212. For example, for temperature sensor 1212-1, both the temperature sensor 1212-1 and the sense resistor R_{SENSE} are being sensed by ADC 1222-1. For temperature sensor 1212-2, both the temperature sensor 1212-2 and the sense resistor R_{SENSE} are being sensed by ADC 1222-2, and so on.

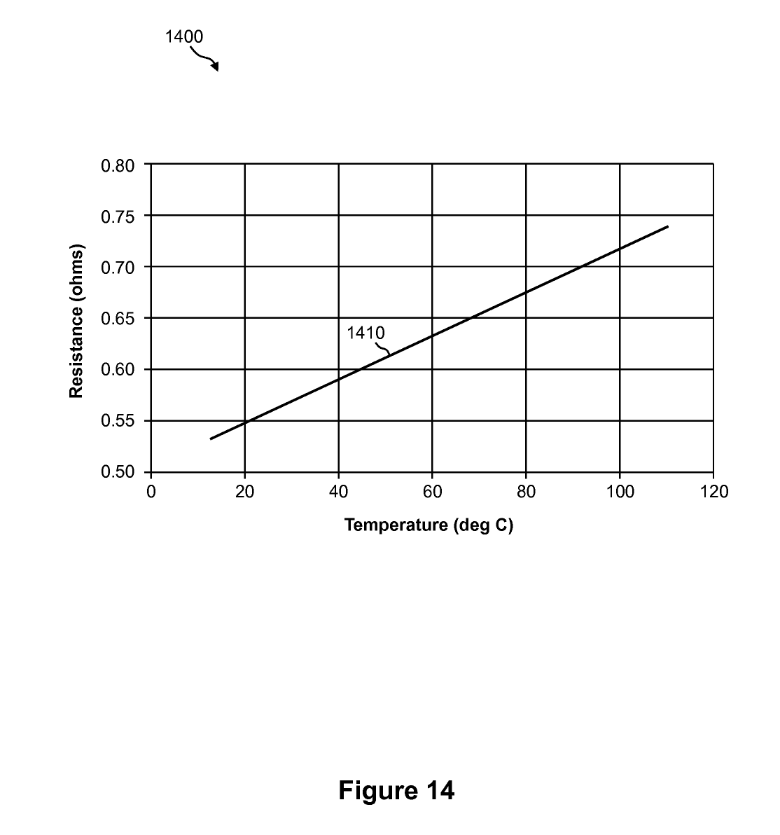

FIG. 14 shows an example of a plot 1400, which is a plot of the resistance vs. temperature for a copper temperature sensor 1212 at, for example, 35 mA of excitation current. Plot 1400 shows a sensor characterization curve 1410 that has a certain slope m and intercept b. Namely, sensor characterization curve 1410 shows the transfer function relating resistance and temperature, which can be used to predict one value (e.g., temperature) from another value (e.g., resistance), or vice versa. In another example, a look up table or piecewise function could be used to predict temperature from resistance.

The temperature dependence of resistance is given by the following equation:

R=R₀(1+α(T−T₀))
where: R=resistance of sensor trace at temperature T
   R₀=nominal resistance of sensor trace at nominal temperature T₀
   alpha (α)=temperature coefficient of resistance, specific to T₀
      For example, for annealed copper, αₘ is about 0.393%/deg C.

In the example shown in FIG. 14, the data is fit with a linear function of the form y=m*x+b using a least squares technique which results in the slope, m=2.110e−3 and intercept b=5.063e−1. From that, R₀ and alpha can be calculated to be R₀=0.5485, and alpha (α)=0.003847. By algebraic manipulation of the two equivalent linear functions R=m*T+b and R=R₀*(1+alpha*(T−T₀)), R₀=m×T₀+b and α=m/R₀. For this example, it follows that R₀=0.5485 ohms and α=m/R₀=0.003847.

Sensor characterization curve 1410 shows that the resistance of a trace changes with temperature, thus it may be beneficial to calibrate the temperature sensors 1212 at a temperature that is close to the expected operating temperature of the droplet actuator 1210. In the example shown in plot 1400, wherein sensor characterization curve 1410 is substantially linear, it is sufficient to calibrate the temperature sensors 1212 at one temperature only. However, in other embodiments, it may be beneficial to calibrate the temperature sensors 1212 at two different temperatures. For example, it may be beneficial to calibrate the temperature sensors 1212 at two different temperatures when using materials that have non-linear resistance/temperature characteristics.

Referring now again to FIG. 13, the purpose of the calibration process is to (1) determine the nominal resistance R₀ of each of the temperature sensors 1212-1 through 1212-n at a known temperature, such as at 20° C.; and (2) determine the temperature coefficient of resistance a of each of the temperature sensors 1212-1 through 1212-n. Preferably, the calibration temperature is selected to be about the same as the expected operating temperature of droplet actuator 1210.

Sense resistor R_{SENSE} is a known resistance value, therefore by reading the voltage across sense resistor R_{SENSE} the current through sense resistor R_{SENSE} and all of the temperature sensors 1212-1 through 1212-n can be calculated. Then, knowing the amount of current, the voltage is measured across each of the temperature sensors 1212-1 through 1212-n and then the resistance of each of the temperature sensors 1212-1 through 1212-n can be calculated. This calibration process is conducted at a certain temperature. In this way, the nominal resistance R₀ of each of the temperature sensors 1212-1 through 1212-n at about 20° C. is determined.

The result of the calibration is (1) a resistance value at a certain temperature and (2) a temperature coefficient of resistance a at the certain temperature for each of the temperature sensors 1212-1 through 1212-n. Further, multiple values at multiple temperatures can be stored for each of the temperature sensors 1212-1 through 1212-n.

The goal of the calibration procedure is to obtain resistance of the sense traces independent of others effects in the system. Resistance is not measured directly. Rather, it is defined as the ratio of voltage across a device to the current through it. Because of this, it is very important to accurately measure the voltage and current. Because the output is a ratio, gain errors in the system cancel. By “ratioing” the differences of measurements, offset errors are discounted. Therefore, with respect reducing or substantially eliminating measurement errors, a process can be used to selectively measure the resistance of the sense traces and exclude, for example systematic measurement errors due to, for example, thermal voltages and other common long time scale errors in the analog instrumentation (such as offset and gain errors). Namely, in a first step, a first current value is set at programmable current source 1230, then a first differential voltage measurement V_{SENSOR1} is taken and stored for each of the temperature sensors 1212-1 through 1212-n. Further, a first differential voltage measurement V_{SENSE1} is taken and stored for sense resistor R_{SENSE}.

In a second step, a second current value is set at programmable current source 1230, then a second differential voltage measurement V_{SENSOR2} is taken and stored for each of the temperature sensors 1212-1 through 1212-n. Further, a second differential voltage measurement V_{SENSE2} is taken and stored for sense resistor R_{SENSE}.

In a third step, the resistance is calculated as a ratio for each temperature sensor 1212; namely, the resistance ratio=dV/dI, where dI=(1/R_{SENSE})×(V_{SENSE2}−V_{SENSE1}) and dV=V_{SENSOR2}−V_{SENSOR1}. The value of Rsense is stored as part of instrument calibration (or can be controlled sufficiently well by design). Using the known value of sense resistor R_{SENSE} and the various measurements, the resistance of a sense trace can be calculated. For example: R=R_{SENSE}×(V_{SENSOR2}−V_{SENSOR1})/(V_{SENSE2}−V_{SENSE1}). With the resistance of the trace known, the known transfer function for that trace can be used to determine its temperature.

It will be appreciated that various aspects of the invention may be embodied as a method, system, computer readable medium, and/or computer program product. Aspects of the invention may take the form of hardware embodiments, software embodiments (including firmware, resident software, micro-code, etc.), or embodiments combining software and hardware aspects that may all generally be referred to herein as a “circuit,” “module,” or “system.” Furthermore, the methods of the invention may take the form of a computer program product on a computer-usable storage medium having computer-usable program code embodied in the medium.

Any suitable computer useable medium may be utilized for software aspects of the invention. The computer-usable or computer-readable medium may be, for example but not limited to, an electronic, magnetic, optical, electromagnetic, infrared, or semiconductor system, apparatus, device, or propagation medium. The computer readable medium may include transitory and/or non-transitory embodiments. More specific examples (a non-exhaustive list) of the computer-readable medium would include some or all of the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission medium such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Program code for carrying out operations of the invention may be written in an object oriented programming language such as Java, Smalltalk, C++ or the like. However, the program code for carrying out operations of the invention may also be written in conventional procedural programming languages, such as the “C” programming language or similar programming languages. The program code may be executed by a processor, application specific integrated circuit (ASIC), or other component that executes the program code. The program code may be simply referred to as a software application that is stored in memory (such as the computer readable medium discussed above). The program code may cause the processor (or any processor-controlled device) to produce a graphical user interface (“GUI”). The graphical user interface may be visually produced on a display device, yet the graphical user interface may also have audible features. The program code, however, may operate in any processor-controlled device, such as a computer, server, personal digital assistant, phone, television, or any processor-controlled device utilizing the processor and/or a digital signal processor.

The program code may locally and/or remotely execute. The program code, for example, may be entirely or partially stored in local memory of the processor-controlled device. The program code, however, may also be at least partially remotely stored, accessed, and downloaded to the processor-controlled device. A user's computer, for example, may entirely execute the program code or only partly execute the program code. The program code may be a stand-alone software package that is at least partly on the user's computer and/or partly executed on a remote computer or entirely on a remote computer or server. In the latter scenario, the remote computer may be connected to the user's computer through a communications network.

The invention may be applied regardless of networking environment. The communications network may be a cable network operating in the radio-frequency domain and/or the Internet Protocol (IP) domain. The communications network, however, may also include a distributed computing network, such as the Internet (sometimes alternatively known as the “World Wide Web”), an intranet, a local-area network (LAN), and/or a wide-area network (WAN). The communications network may include coaxial cables, copper wires, fiber optic lines, and/or hybrid-coaxial lines. The communications network may even include wireless portions utilizing any portion of the electromagnetic spectrum and any signaling standard (such as the IEEE 802 family of standards, GSM/CDMA/TDMA or any cellular standard, and/or the ISM band). The communications network may even include powerline portions, in which signals are communicated via electrical wiring. The invention may be applied to any wireless/wireline communications network, regardless of physical componentry, physical configuration, or communications standard(s).

Certain aspects of invention are described with reference to various methods and method steps. It will be understood that each method step can be implemented by the program code and/or by machine instructions. The program code and/or the machine instructions may create means for implementing the functions/acts specified in the methods.

The program code may also be stored in a computer-readable memory that can direct the processor, computer, or other programmable data processing apparatus to function in a particular manner, such that the program code stored in the computer-readable memory produce or transform an article of manufacture including instruction means which implement various aspects of the method steps.

The program code may also be loaded onto a computer or other programmable data processing apparatus to cause a series of operational steps to be performed to produce a processor/computer implemented process such that the program code provides steps for implementing various functions/acts specified in the methods of the invention.

### 8 CONCLUDING REMARKS

The foregoing detailed description of embodiments refers to the accompanying drawings, which illustrate specific embodiments of the invention. Other embodiments having different structures and operations do not depart from the scope of the present invention. The term “the invention” or the like is used with reference to certain specific examples of the many alternative aspects or embodiments of the applicants' invention set forth in this specification, and neither its use nor its absence is intended to limit the scope of the applicants' invention or the scope of the claims. This specification is divided into sections for the convenience of the reader only. Headings should not be construed as limiting of the scope of the invention. The definitions are intended as a part of the description of the invention. It will be understood that various details of the present invention may be changed without departing from the scope of the present invention. Furthermore, the foregoing description is for the purpose of illustration only, and not for the purpose of limitation.

1. A method of on-actuator temperature measurement and control, comprising providing one or more droplets on a droplet actuator and measuring the temperature of the one or more droplets with one or more temperature sensors on the droplet actuator, wherein each of the one or more temperature sensors comprise a temperature sensor wiring trace and a connection, wherein the connection comprises a plurality of terminals configured to enable application of an amount of current from a current source and measurement of a voltage, wherein the voltage correlates to a temperature.

2. The method of claim 1, wherein the temperature sensor wiring trace is disposed on a printed circuit board (PCB).

3. The method of claim 1, wherein at least one of the connections is a Kelvin electrical connection.

4. The method of claim 3, wherein the Kelvin electrical connection comprises a resistor R1.

5. The method of claim 4, wherein the resistor R1 is configured to measure the resistance of the one or more temperature sensors.

6. The method of claim 3, wherein the Kelvin electrical connection comprises a 4-terminal Kelvin connection.

7. The method of claim 6, wherein the 4-terminal Kelvin connection comprises a terminal T1, a terminal T2, a terminal T3, and a terminal T4.

8. The method of claim 7, wherein the terminal T1 and the terminal T2 comprise current terminals.

9. The method of claim 8, wherein the resistor R1 is arranged between the terminal T1 and the terminal T2.

10. The method of claim 9, wherein the terminal T1 and the terminal T2 are configured to be driven by the current source.

11. The method of claim 10, wherein the current source is a constant current source.

12. The method of claim 7, wherein the Kelvin electrical connection further comprises a resistor R2 and a resistor R3.

13. The method of claim 12, wherein the Kelvin electrical connection further comprises a loop comprising the resistor R1, the resistor R2, the resistor R3, and the current source.

14. The method of claim 7, wherein the terminal T3 and the terminal T4 comprise sense terminals.

15. The method of claim 7, wherein the terminal T3 and the terminal T4 are configured to measure the voltage across resistor R1.

16. The method of claim 7, wherein the Kelvin electrical connection further comprises a resistor R4 and a resistor R5.

17. The method of claim 16, wherein the Kelvin electrical connection further comprises a loop comprising the resistor R1, the resistor R4, the resistor R5, and the voltage.

18. The method of claim 6, wherein one of the one or more temperature sensors comprises a first temperature sensor comprising the 4-terminal Kelvin connection, and further wherein one or more additional temperature sensors comprise 2-terminal connections.

19. The method of claim 6, wherein the connections are configured to enable current to run in series through the first temperature sensor and the one or more additional temperature sensors.

20. The method of claim 18, wherein the one or more additional temperature sensors share the same current source.

21. The method of claim 1, wherein the droplet actuator further comprises one or more heaters, wherein each of the one or more heaters comprise a heater wiring trace.

22. The method of claim 21, wherein each of the one or more temperature sensors corresponds to a heater, thereby forming one or more temperature sensor-heater pairs.

23. The method of claim 22, wherein the temperature sensor wiring trace and the heater wiring trace of each of the one or more temperature sensor-heater pairs comprise the same wiring trace.

24. The method of claim 1, wherein the droplet actuator is configured to prevent the temperature of the temperature sensor wiring trace from increasing by more than about 0.1° C.

25. The method of claim 24, wherein the droplet actuator is configured to enable pulsed measurements.

26. The method of claim 24, wherein the droplet actuator is configured to enable oversampling using continuous measurement.

27. The method of claim 1, wherein the droplet actuator is configured to enable exclusion of a thermal electromotive force (EMF) from the measurement of the voltage.

28. The method of claim 27, wherein the droplet actuator is configured to enable exclusion of the thermal EMF from the measurement of the voltage through via an Offset Compensation method.

29. The method of claim 27, wherein the droplet actuator is configured to enable exclusion of the thermal EMF from the measurement of the voltage through via a Current Reversal method.

30. The method of claim 27, wherein the droplet actuator is configured to enable exclusion of the thermal EMF from the measurement of the voltage through via a Delta method.

31. The method of claim 27, wherein the droplet actuator is configured to enable exclusion of the thermal EMF from the measurement of the voltage through via a Lock-in method.

32. The method of claim 1, wherein the temperature sensor wiring trace is configured to form a defined shape or geometric pattern.

33. The method of claim 32, wherein the temperature sensor wiring trace is configured to form a substantially circular pattern.

34. The method of claim 32, wherein the temperature sensor wiring trace is configured to form a substantially square pattern.

35. The method of claim 33, wherein the temperature sensor wiring trace comprises a 7-loop temperature sensor.

36. The method of claim 33, wherein the temperature sensor wiring trace comprises a 5-loop temperature sensor.

37. The method of claim 33, wherein the temperature sensor wiring trace comprises a 3-loop temperature sensor.

38. The method of claim 33, wherein the temperature sensor wiring trace comprises a 1-loop temperature sensor.

39. The method of claim 35, wherein the temperature sensor wiring trace also comprises an on-actuator temperature sensor.

40. The method of claim 35, wherein at least one of the connections is a Kelvin electrical connection.

41. The method of claim 40, wherein the Kelvin electrical connection comprises a resistor R1.

42. The method of claim 41, wherein the resistor R1 is configured to measure the resistance of the one or more temperature sensors.

43. The method of claim 42, wherein the Kelvin electrical connection comprises a 4-terminal Kelvin connection.

44. The method of claim 43, wherein the 4-terminal Kelvin connection comprises a terminal T1, a terminal T2, a terminal T3, and a terminal T4.

45. The method of claim 44, wherein the temperature sensor wiring trace comprises a continuous wiring trace.

46. The method of claim 45, wherein the continuous wiring trace is configured in a serpentine shape comprising one or more concentric circles about a center point.

47. The method of claim 45, wherein the continuous wiring trace is configured in a serpentine shape comprising one or more concentric squares about a center point.

48. The method of claim 46, wherein terminals T1 and T3 are located at one end of the temperature sensor wiring trace and terminals T2 and T4 are located at the other end of the temperature sensor wiring trace.

49. The method of claim 48, wherein the temperature sensor wiring trace corresponds to resistor R1.

50. The method of claim 49, wherein the droplet actuator further comprises one or more heaters, wherein each of the one or more heaters comprises a heater wiring trace.

51-95. (canceled)
